(19) United States
(12) Patent Application Publication
(10) Pub. No.: US 2013/0271251 A1
(43) Pub. Date: Oct. 17, 2013

(54) Substrate-Less Electronic Component

(71) Applicants: Shih-Hsien Tseng, Hsinchu County (TW); Wen-Hsiung Liao, Hsinchu County (TW); Joseph D.S. Deng, Taoyuan County (TW); Ian-Chun Cheng, Taoyuan County (TW)

(72) Inventors: Shih-Hsien Tseng, Hsinchu County (TW); Wen-Hsiung Liao, Hsinchu County (TW); Joseph D.S. Deng, Taoyuan County (TW); Ian-Chun Cheng, Taoyuan County (TW)

(73) Assignee: Cyntec Co., Ltd., Hsinchu (TW)

(21) Appl. No.: 13/571,381

(22) Filed: Aug. 10, 2012

Related U.S. Application Data
(60) Provisional application No. 61/623,075, filed on Apr. 12, 2012.

(51) Int. Cl. H01F 5/00; H01F 41/04

(52) U.S. Cl. 336/200; 264/104

(57) ABSTRACT

The present invention discloses a substrate-less electronic component. A conductive element is disposed in the plurality of insulating layers, wherein the plurality of insulating layers are not supported by a substrate. The substrate-less electronic component can be manufactured by performing film process on a plurality of conductive layers or insulating layers on the substrate before the substrate is removed. In one embodiment, a buffer layer can be formed on the substrate. After the process is done, the buffer layer can be easily removed to decouple the substrate from the layers on the substrate.

### BACKGROUND OF THE INVENTION

I. Field of the Invention

The present invention relates to an electronic component and, in particular, to a substrate-less electronic component.

II. Description of the Prior Art

A technique for manufacturing a low temperature co-fired ceramic (hereinafter, being referred to as “LTCC”) substrate is a process in which an internal electrode and passive elements (R, L, and C) for given circuits are formed in a green sheet made of glass ceramic by a screen printing method using a metal with high electric conductivity such as Ag, Cu, etc., and a plurality of the green sheets are stacked vertically and then fired (generally at less than 1,000° C.) so as to manufacture MCM (multi-chip modules) and multi-chip packages.

Since the ceramic substrate and the metallic elements are co-fired, the LTCC technique can form the passive elements (R, L, and C) within a module, thereby obtaining a complex configuration including many components and being advantageous in terms of miniaturization.

The LTCC multilayer substrate is formed by forming circuits in a single ceramic substrate and vertically stacking a plurality of the ceramic substrates. Therefore, external terminals to be connected to the outside must be formed on an outer surface of the LTCC substrate and electrically connected to circuit patterns within the substrate.

Please refer to FIG. 1. Conventionally, a device 100 (e.g., an inductor) comprises a substrate 101, a body 102, a coil 103 and a pair of external electrodes 104, wherein the coil 103 is formed in the body 102 by LTCC process. The substrate 101 is a ceramic substrate. The body 102 including the coil 103 therein is disposed on the top surface 107 of the substrate 101. The coil 103 is usually made of Ag. A pair of external electrodes 104 electrically connected to the coil 103 is configured from the top surface 107 of the substrate 101, along the lateral surface 108 of the substrate 101, to the bottom surface 109 of the substrate 101. Some drawbacks in the device 100 include: a. the residual inductance of a portion of external electrodes 104 on the lateral surface 108 of the substrate 101 is determined by the thickness of the substrate 101, and Q-factor performance is not easily enhanced; b. the conductivity of external electrodes 104 on the lateral surface 108 of the substrate 101 is worse due to the poor adhesion of the metallic film by the sputtering process; c. the material of the insulating layers in the body 102 between the coil 103 and the substrate 101 is different, which will induce additional stress due to thermal effect and reduce the wafer yield; d. because the ceramic substrate 101 is too hard to perform die-trimming easily, it is difficult to design a slim-type device. Accordingly, the present invention proposes a package structure and a manufacturing method thereof to overcome the above-mentioned disadvantages.

### SUMMARY OF THE INVENTION

One objective of the present invention is to provide a substrate-less electronic component comprising a conductive element; and a plurality of insulating layers, wherein the conductive element is disposed in the plurality of insulating layers, wherein the plurality of insulating layers are not supported by a substrate.

The substrate-less electronic component can be manufactured by performing film process, such as lithography process, etching process or thin-film process, on a plurality of conductive layers or insulating layers on the substrate before the substrate is removed. Compared to the device formed on the substrate, the thickness of substrate-less device in the present invention is smaller and the device has a better electrical performance. Also, the size of the electronic component can be smaller and more precise by performing film process.

Another objective of the present invention is to provide a method for manufacturing an electronic component, the method comprising the steps of: provide a substrate; form a conductive element and a plurality of insulating layers on the substrate, wherein the conductive element is disposed in the plurality of insulating layers; and decouple the substrate from the plurality of insulating layers.

In one embodiment, a buffer layer can be formed on the substrate. The buffer layer is a temporary layer for bonding the substrate and the layers in order to process or pattern the layers on the substrate. After the process is done, the buffer layer can be easily removed to decouple the glass substrate from the layers.

Another objective of the present invention is to provide a substrate-less package structure comprising: a conductive element, comprising a first terminal; a body, comprising a first lateral surface with a first opening thereon; and a first electrode electrically connected to the first terminal, wherein the first electrode comprises a first segment substantially disposed in the body and at least one portion of the first segment is exposed to the first lateral surface via the first opening.

In one embodiment, the substrate-less package structure has a portion of at least one electrode in the body. Compared to a device formed on a substrate used for a carrier, the structure has a shorter electrical path (due to having no substrate) and the residual inductance of the electrode is smaller so that it can have a better Q value. Furthermore, it can have the flexibility and the versatility of the layer number, pattern size or through hole about at least one electrode in the body. Because the substrate of large size is omitted, the material of package structure is almost the same so that there is no thermal effect or stress effect on the package structure.

Another objective of the present invention is to provide a stacking structure comprising: a substrate having a first lateral surface and a second lateral surface opposite to the first lateral surface; and a plurality of conductive layers disposed in the substrate, wherein each two adjacent layers of the plurality of conductive layers are contacted each other in a contact region, wherein the contact regions of the plurality of conductive layers are interleaved along the first lateral surface and the second lateral surface.

Another objective of the present invention is to provide a M2-stacking-structure comprising: a first insulating layer having a first through-hole; a first conductive layer disposed on the first insulating layer, wherein the first conductive layer has a first connection portion and a second connection portion, wherein the first connection portion is disposed in the first through-hole; a second insulating layer disposed on the first conductive layer, wherein the second insulating layer has a second through-hole located on the second connection portion of the first conductive layer; and a second conductive layer disposed on the second insulating layer, wherein the second conductive layer has a third connection portion and a fourth connection portion, wherein the third connection portion of the second conductive layer is disposed in the second through-hole and is electrically connected to the second connection portion of the first conductive layer. The stacking structure for the electrical connection of the adjacent conductive layers and the manufacturing method thereof doesn't a complex process. The applications of the stacking structure in the present invention can be extended to a repeat stacking structure, such as M3-stacking-structure or M4-stacking-structure. Preferably, the stacking structure for aligning a conductive element is an electrode.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 illustrates a schematic cross-sectional view of the structure of the device (with a substrate);

FIG. 2 illustrates a schematic cross-sectional view of the structure of the substrate-less package device;

FIG. 3A illustrates a schematic XY-plane cross-sectional view of the structure of the package structure with at least one electrode;

FIG. 3B illustrates a schematic XY-plane cross-sectional view of the structure of the package structure with at least one electrode exposed to the lateral surface of the body via the opening;

FIG. 3C illustrates a schematic YZ-plane cross-sectional view of the structure of the package structure with at least one electrode;

FIG. 3D illustrates a schematic YZ-plane cross-sectional view of the structure 300 of the package structure with at least one electrode in a preferred embodiment;

FIG. 3E illustrates a schematic XY-plane cross-sectional view of the structure of the package structure with at least one electrode and at least one pad;

FIG. 3F illustrates a schematic XY-plane cross-sectional view of the structure of the package structure with at least one electrode exposed to the lateral surface of the body via the opening and at least one pad;

FIG. 4A illustrates a schematic XY-plane cross-sectional view of the structure of the package structure with a first electrode and a second electrode;

FIG. 4B illustrates a schematic XY-plane cross-sectional view of the structure of the package structure with a first electrode exposed to the first lateral surface of the body via the first opening and a second electrode exposed to the second lateral surface of the body via the second opening;

FIG. 4C illustrates a schematic YZ-plane cross-sectional view of the structure of the package structure with a first electrode and a second electrode;

FIG. 4D illustrates a schematic YZ-plane cross-sectional view of the structure of the package structure with a first electrode and a second electrode in a preferred embodiment;

FIG. 4E illustrates a schematic XY-plane cross-sectional view of the structure of the package structure with a first electrode, a first pad, a second electrode and a second pad;

FIG. 4F illustrates a schematic XY-plane cross-sectional view of the structure of the package structure with a first electrode exposed to the first lateral surface of the body via the first opening, a first pad, a second electrode exposed to the second lateral surface of the body via the second opening and a second pad;

FIG. 5 is a graph showing Q factor versus frequency in the present invention compared with that in the prior art;

FIG. 6A illustrates the process flow of manufacturing the structure in FIG. 2, the structure in FIG. 3A and the structure in FIG. 4A;

FIG. 6B to FIG. 6H illustrate the process flow for manufacturing the structure in FIG. 4A in detail;

FIG. 7A illustrates a schematic cross-sectional view of the electrical-connection structure of the adjacent conductive layers, wherein the adjacent conductive layers need a via layer therebetween;

FIG. 7B to FIG. 7E illustrates the process flow of manufacturing the structure in FIG. 7A;

FIG. 7F illustrates a schematic cross-sectional view of the electrical-connection structure used in the present invention;

FIG. 7G to FIG. 7I illustrates the process flow of manufacturing the structure in FIG. 7F;

FIG. 8A illustrates a schematic cross-sectional view of the ideal stacking structure for the electrical connection of the adjacent conductive layers.

FIG. 8B illustrates a schematic cross-sectional view of the real stacking structure for the electrical connection of the adjacent conductive layers.

FIG. 8C illustrates a schematic cross-sectional view of the simplified stacking structure for the electrical connection of the adjacent conductive layers.

FIG. 8D illustrates a schematic cross-sectional view of the simplified stacking structure in another embodiment for the electrical connection of the adjacent conductive layers;

FIG. 8E illustrates a schematic cross-sectional view of the simplified stacking structure in yet another embodiment for the electrical connection of the adjacent conductive layers;

FIG. 8F illustrates a schematic cross-sectional view of the simplified stacking structure for the electrical connection of the adjacent conductive layers, wherein the stacking structure comprises a substrate;

FIG. 9 illustrates a process flow of a method for manufacturing the structure in

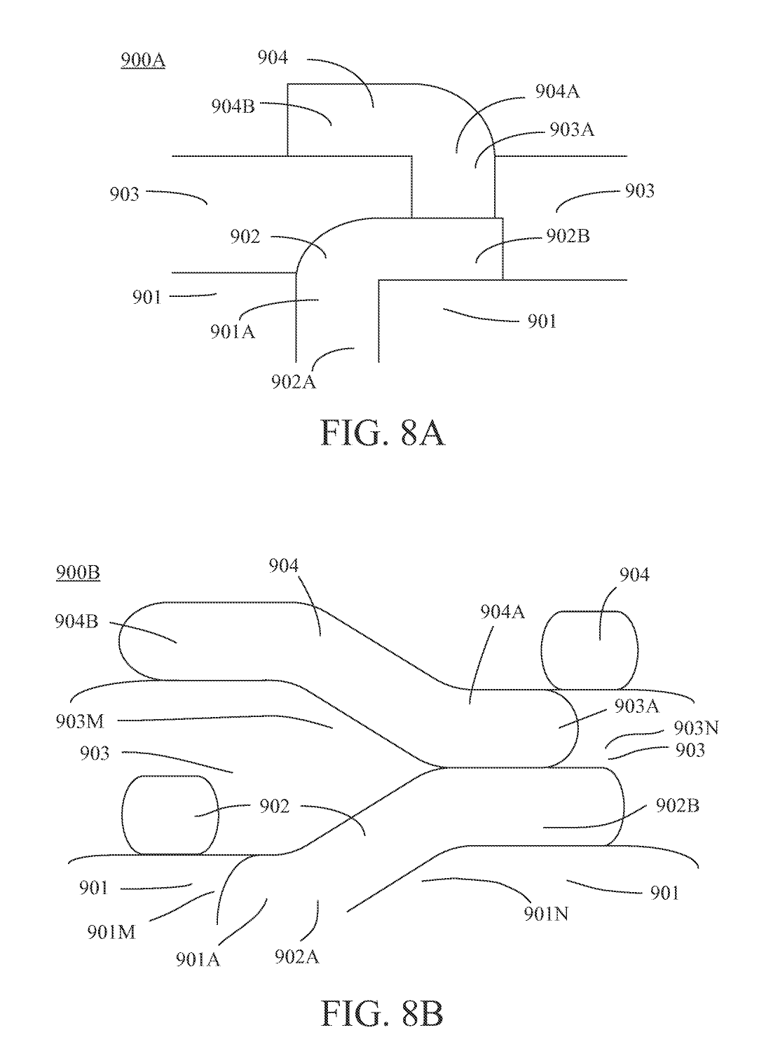

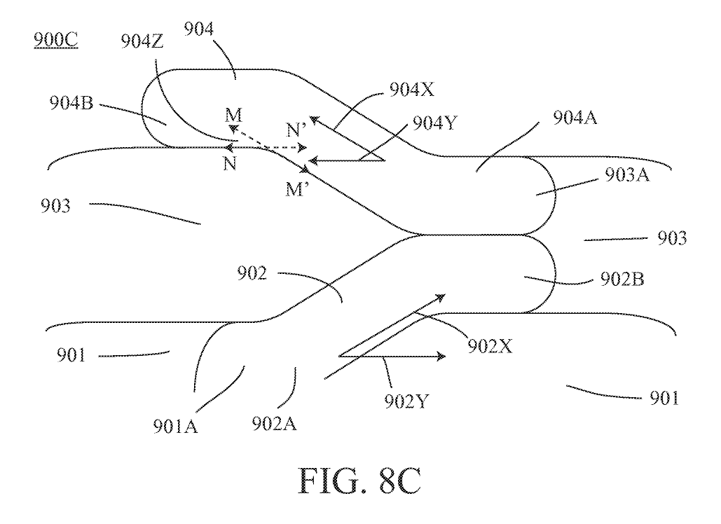

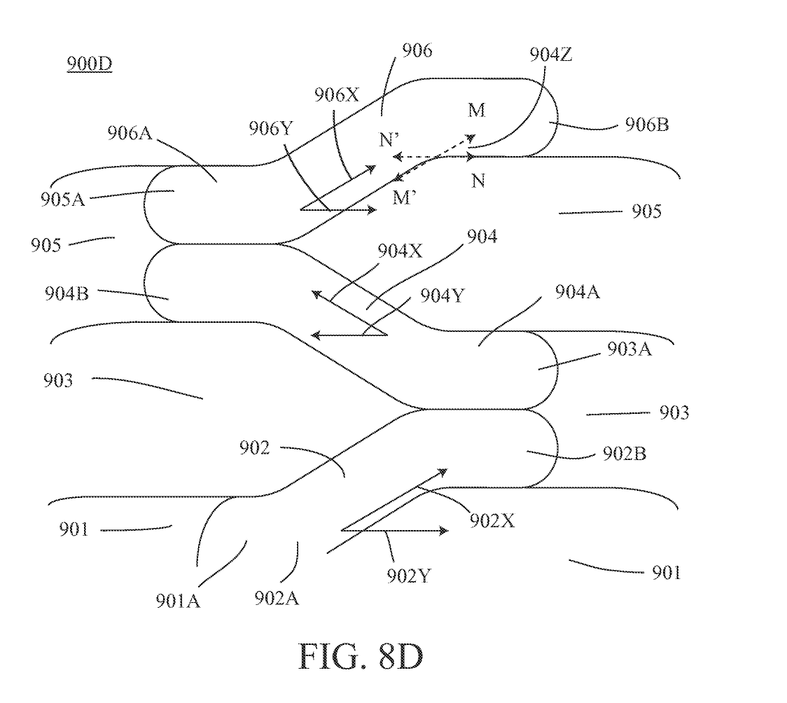

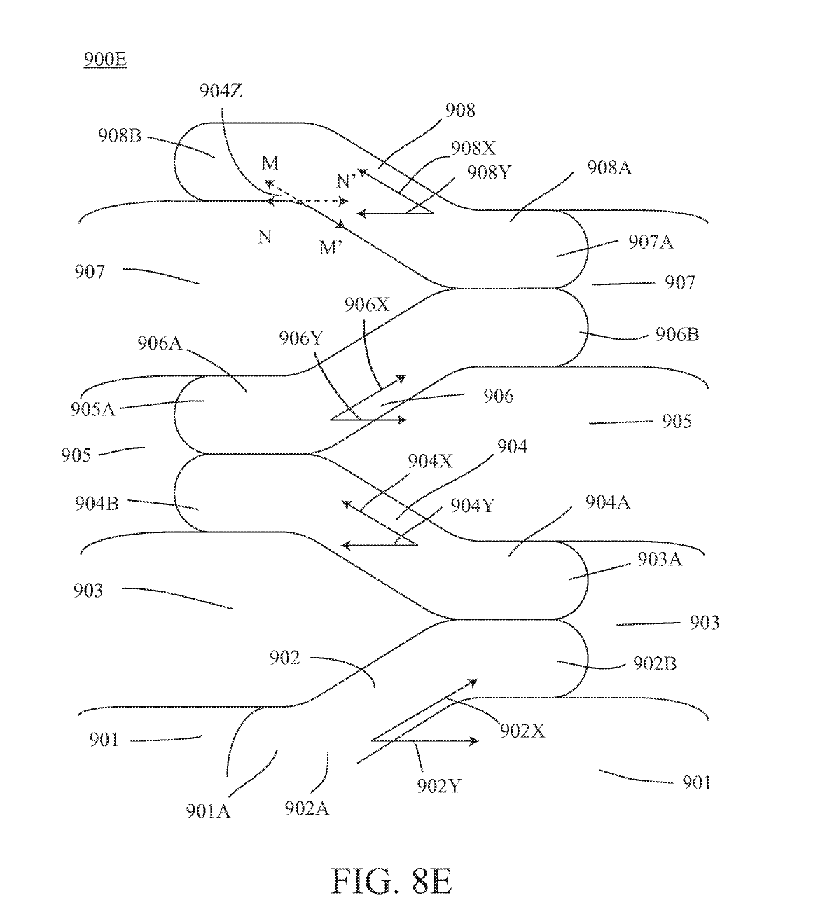

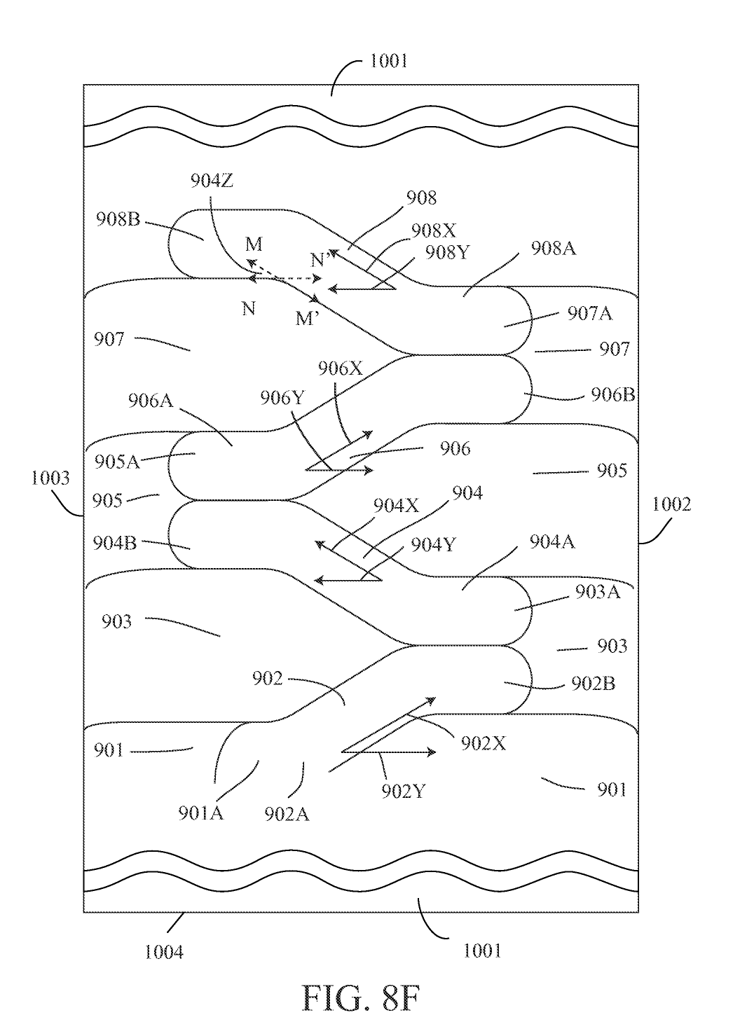

FIG. 8C in the present invention;

FIG. 10A illustrates a schematic cross-sectional view of a photoresist layer patterned in first insulating layer;

FIG. 10B illustrates a schematic cross-sectional view of the first conductive layer formed in the location which the photoresist layer has been developed;

FIG. 10C illustrates a schematic cross-sectional view after removing the photoresist layer;

FIG. 11A illustrates all layout patterns in a package structure;

FIG. 11B illustrates a schematic XY-plane cross-sectional view of the structure of the package structure;

FIG. 11C illustrates a schematic A₁A₂A₃A₄-plane cross-sectional view of the structure;

FIG. 11D illustrates a schematic B₁B₂B₃B₄-plane cross-sectional view of the structure;

FIG. 11E illustrates a schematic B₁B₂B₃B₄-plane cross-sectional view of the preferred structure.

### DETAILED DESCRIPTION OF THE INVENTION

The detailed explanation of the present invention is described as follows. The described preferred embodiments are presented for purposes of illustrations and description and they are not intended to limit the scope of the present invention.

The present invention discloses a substrate-less electronic component. The substrate-less electronic component can be manufactured by performing film process, such as lithography process, etching process or thin-film process, on a plurality of conductive layers or insulating layers on the substrate before the substrate is removed. For a device formed on a substrate used for a carrier, the external electrical connection path is often routed along the lateral surface of the substrate or via a through hole so that a longer electrical connection path is needed. Compared to the device formed on the substrate, the thickness of substrate-less device in the present invention is smaller and the device has a better electrical performance.

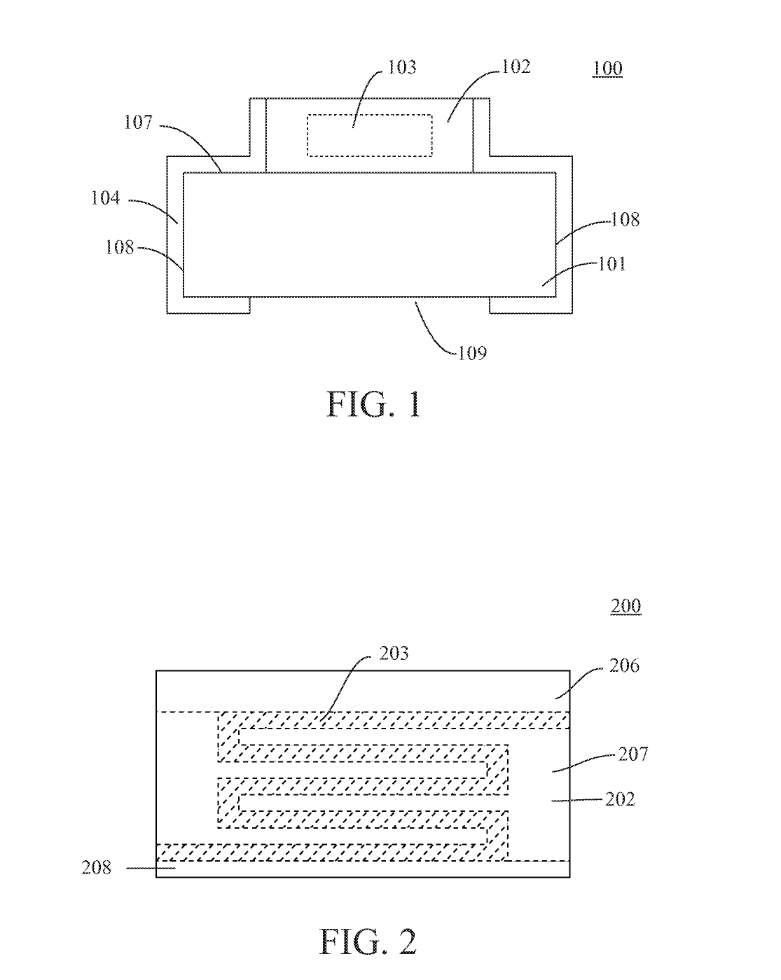

FIG. 2 illustrates a schematic cross-sectional view of the structure 200 of the substrate-less electronic component. The structure 200 includes a conductive element 203 and a plurality of insulating layers 202. The conductive element 203 is disposed in the plurality of insulating layers 202. The plurality of insulating layers 202 are not supported by a substrate.

The plurality of insulating layers 202 can comprise at least one of epoxy, oxide, a polymer-based material or a magnetic material so that film process, such as lithography process, etching process or thin-film process, can be applied to the plurality of insulating layers 202 and the conductive element 203 for patterning. The conductive element 203 can be a coil, an inductor or any other suitable device. In the preferred embodiment, the conductive element 203 is a coil. The coil can be made of any suitable material, such as Cu, Ag, or any other suitable metallic material. The coil can be a multilayer coil, and each layer of the multilayer coil is a conductive layer patterned on an insulating layer. More specifically, the insulating layer is an interlayer between two adjacent conductive layers and there is a through hole in the insulating layer for electrically connecting two adjacent conductive layers. The number of conductive layers of the multilayer coil can be controlled to increase the inductance of the coil.

The plurality of insulating layers 202 substantially comprise a top insulating layer 206, a plurality of median insulating layers 207, a bottom insulating layer 208. More specifically, the conductive element 203 is disposed in the plurality of the median insulating layers 207. The top insulating layer 206 is disposed on the plurality of median insulating layers 207 to protect the conductive element 203 from suffering from the external mechanical interference. Preferably, the thickness of the top insulating layer 206 is greater than that of each of the plurality of median insulating layers 207. The bottom insulating layer 208 is disposed below the plurality of median insulating layers 207. The configuration of the electrodes of the conductive element 203 in the lateral surface of the plurality of insulating layers 202 can be determined by the stacking of top insulating layer 206, a plurality of median insulating layers 207 and a bottom insulating layer 208.

The present invention also discloses a substrate-less package structure with a portion of at least one electrode in the body. Compared to a device formed on a substrate used for a carrier, the structure has a shorter electrical path (due to having no substrate) and the residual inductance of the electrode is smaller so that it can have a better Q value. Furthermore, it can have the flexibility and the versatility of the layer number, the pattern size or the through hole about at least one electrode in the body. Because the substrate of large size is omitted, the material of package structure is almost the same so that there is no thermal effect or stress effect on the package structure.

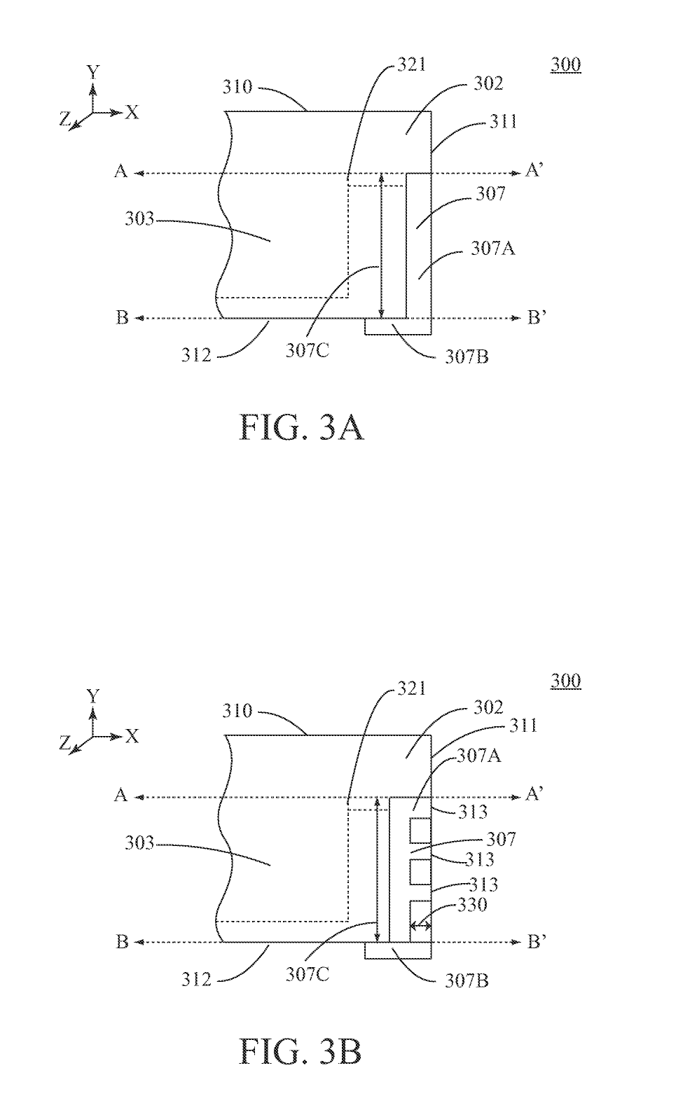

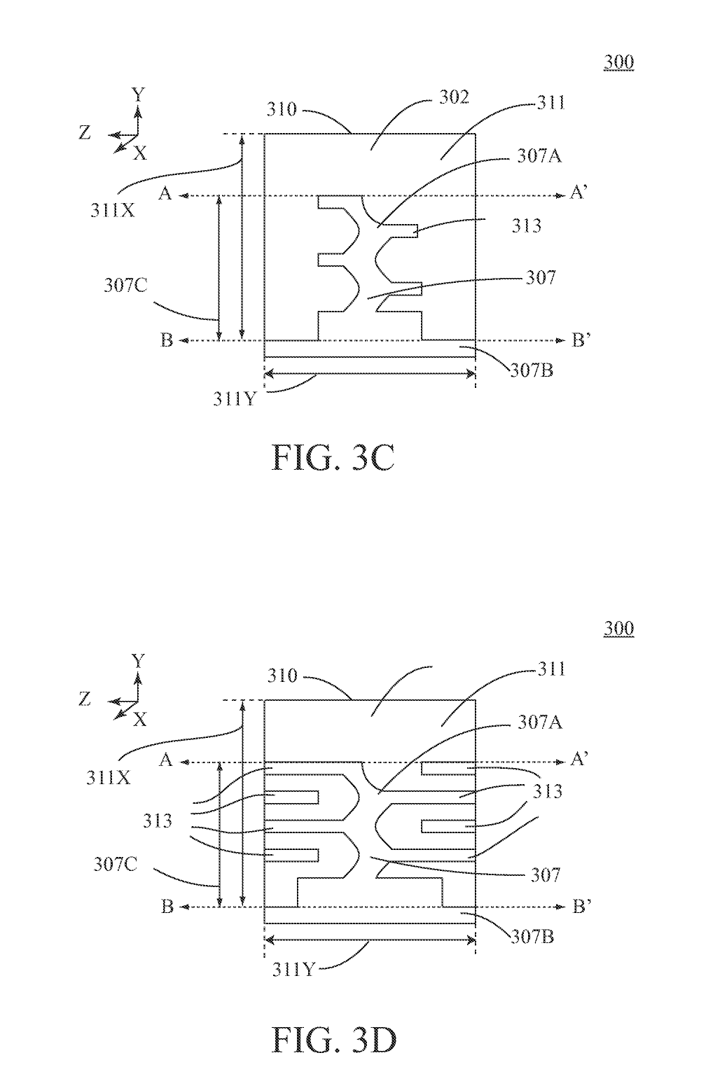

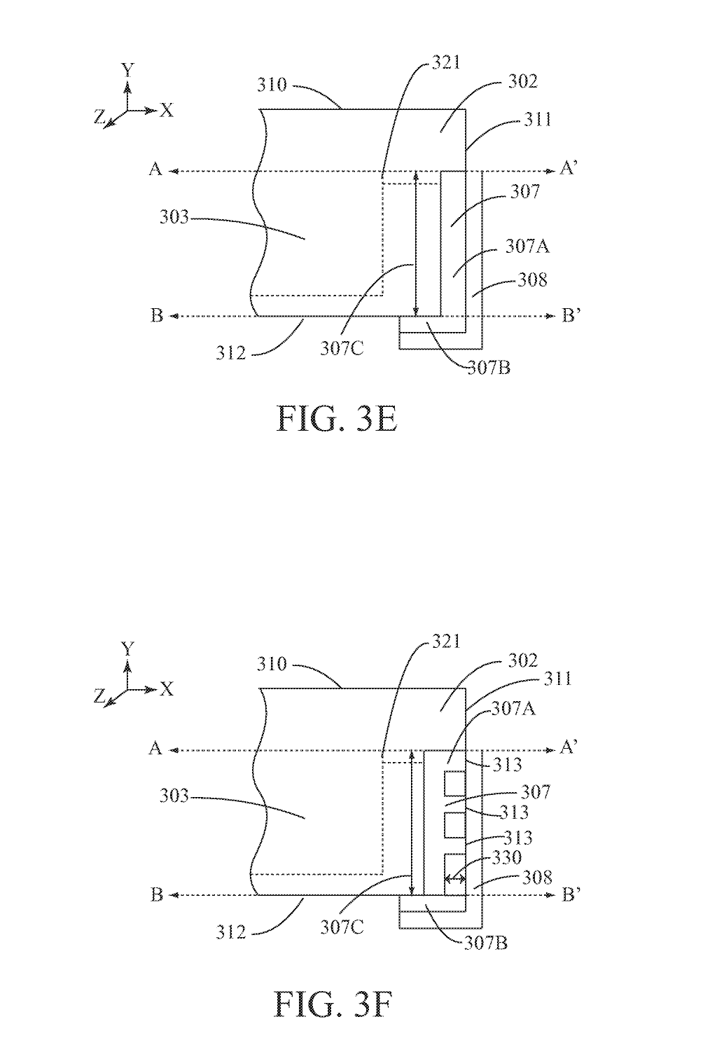

FIG. 3A illustrates a schematic XY-plane cross-sectional view of the structure 300 of the package structure with at least one electrode. The structure 300 can be a portion of any suitable device. The structure 300 can be also a substrate-less package structure similar to the structure 200 in FIG. 2. In FIG. 3A, the package structure 300 merely shows a portion of conductive element 303, a portion of body 302 and a first electrode 307. The body has a top surface 310, a bottom surface 312 and a first lateral surface 311. The first lateral surface 311 has a height 311X and a width 311Y. The top of the first electrode 307 is substantially aligned with line A-A′ and the bottom of the body 302 is substantially aligned with line B-B′. The first electrode 307 has a first segment 307A and a second segment 307B electrically connecting to the first segment 307A. The first segment 307A has a height 307C. Compared to the structure 200 in FIG. 2, the structure 300 has the first segment 307A of the first electrode 307 substantially disposed in the body 302. In one embodiment, one edge of the first segment 307A of the first electrode 307 is aligned with the first lateral surface 311 of the body 302 (see FIG. 3A). In another embodiment, the first segment 307A of the first electrode 307 is separated from the first lateral surface 311 of the body 302 by a distance 330 (see FIG. 3B). Preferably, the distance 330 can be small. The conductive element 303 has a first terminal 321 electrically connected to the first electrode 307. Preferably, the first terminal 321 is electrically connected to the top of the first electrode 307.

FIG. 3C illustrates a schematic YZ-plane cross-sectional view of the structure 300 of the package structure with at least one electrode. FIG. 3D illustrates a schematic YZ-plane cross-sectional view of the structure 300 of the package structure with at least one electrode in a preferred embodiment. The first lateral surface 311 of the body 302 comprises at least one first opening 313 thereon. The first opening 313 can be well-designed and is routed from line A-A′ to line B-B′. At least one portion of the first segment 307A is exposed to the first lateral surface 311 of the body 302 via the first opening 313.

There are many ways to improve the yield of soldering of the first electrode 307 in SMT process. For example, the area of the first opening 313 is substantially at least one-third the projection area of the first segment 307A on the first lateral surface 311. For example, the area of the first opening 313 is substantially at least one-third that of the first lateral surface 311. For example, the height 307C of the first segment 307A is substantially at least one-third the height 311X of the first lateral surface 311. For example, the area of the first opening 313 is less than that of the first lateral surface between line A-A′ and line B-B′. Preferably, the first lateral surface 311 of the body 302 comprises at least one first opening 313 thereon (see FIG. 3D, e.g., a small first opening is disposed between the extending portions of a big first opening to increase opening density.)

Above characteristics described in FIG. 2, such as material or process, can be applied to the structure 300 in FIG. 3A.

The first opening 313 can have any suitable shape for improving the yield of soldering of the first electrode 307 in SMT process. The shape of the first opening 313 depends on the layout designed by the designer, and it will be described hereafter. Preferably, the first opening 313 is zigzag-shaped.

Please refer to FIG. 3E and FIG. 3F. The first electrode 307 is electrically connected to the first pad 308 via the first opening 313 by soldering. The first electrode 307 can be made of a first material (e.g., Cu) and the first pad 308 can be made of a second material (e.g., Sn). In the preferred embodiment, the first electrode 307 can be a first L-shaped electrode. The first L-shaped electrode 307 has a first segment 307A and a second segment 307B electrically connecting to the first segment 307A. The first segment 307A of the first electrode 307 is substantially disposed in the body 302 and the second segment 307B of the first electrode 307 is substantially on the bottom surface 312 of the body 302. The first pad 308 can be a first L-shaped pad for soldering process.

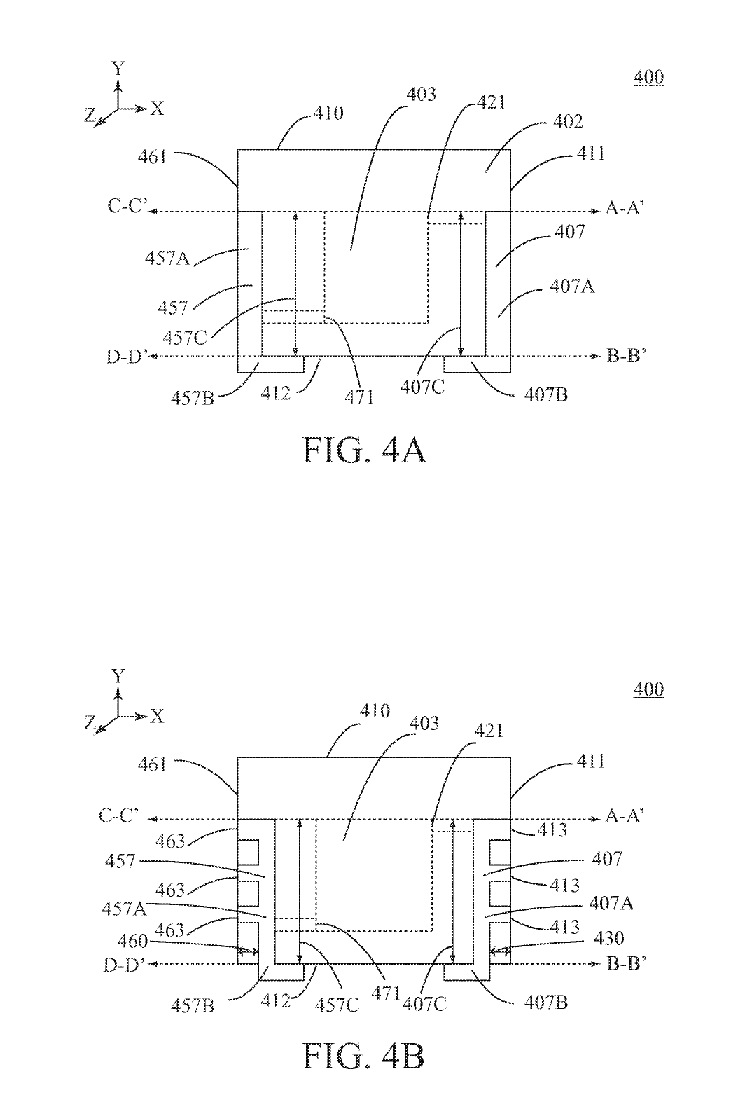

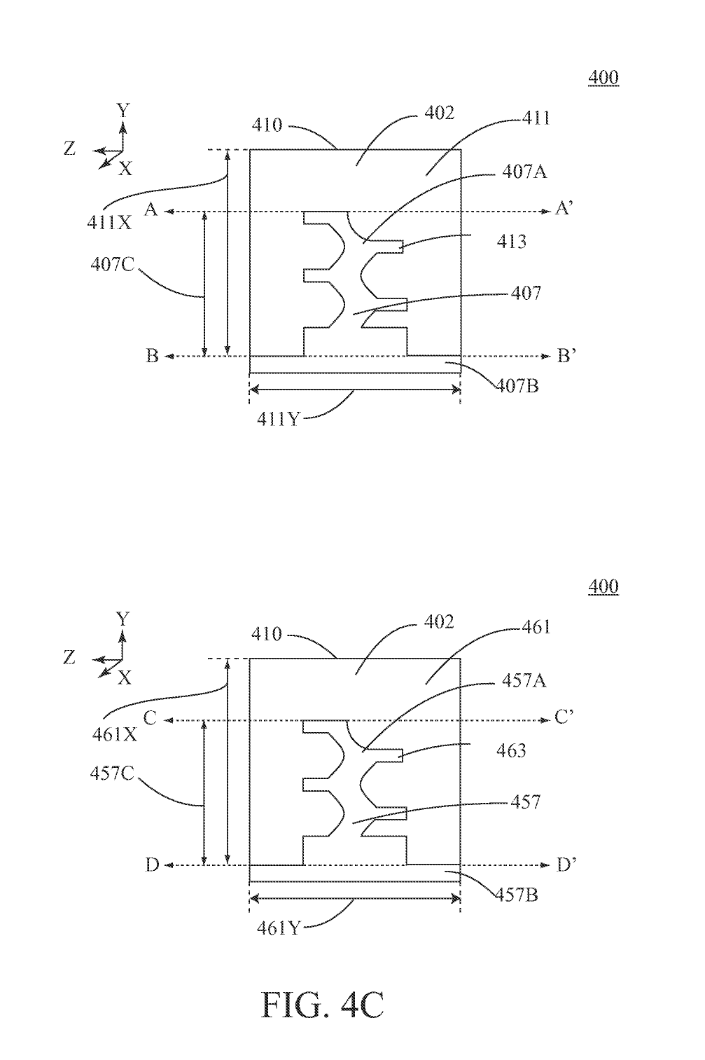

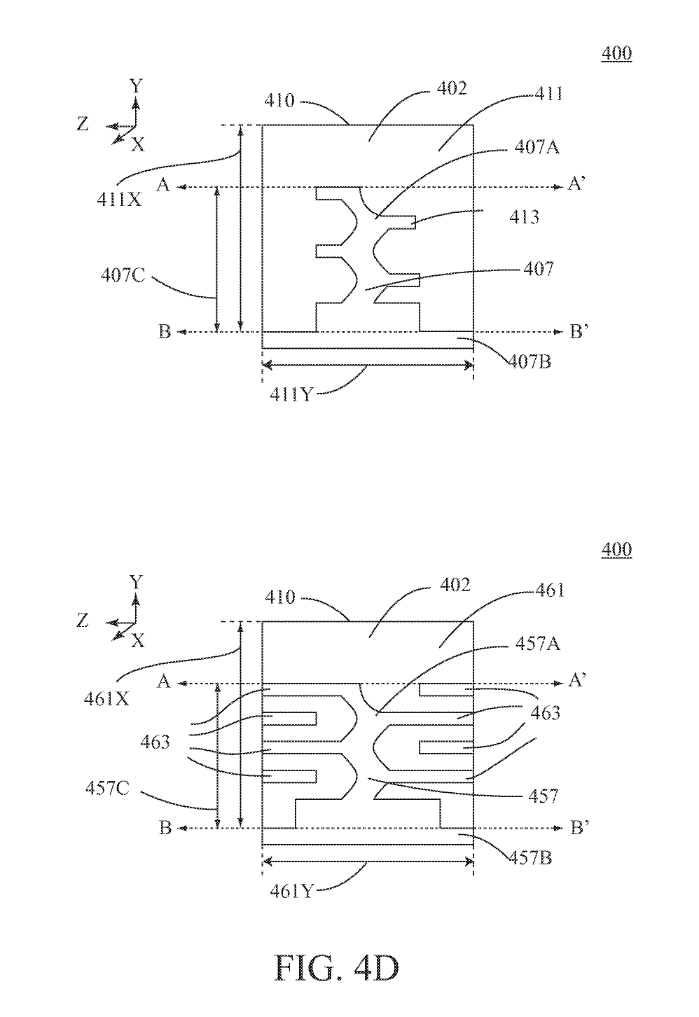

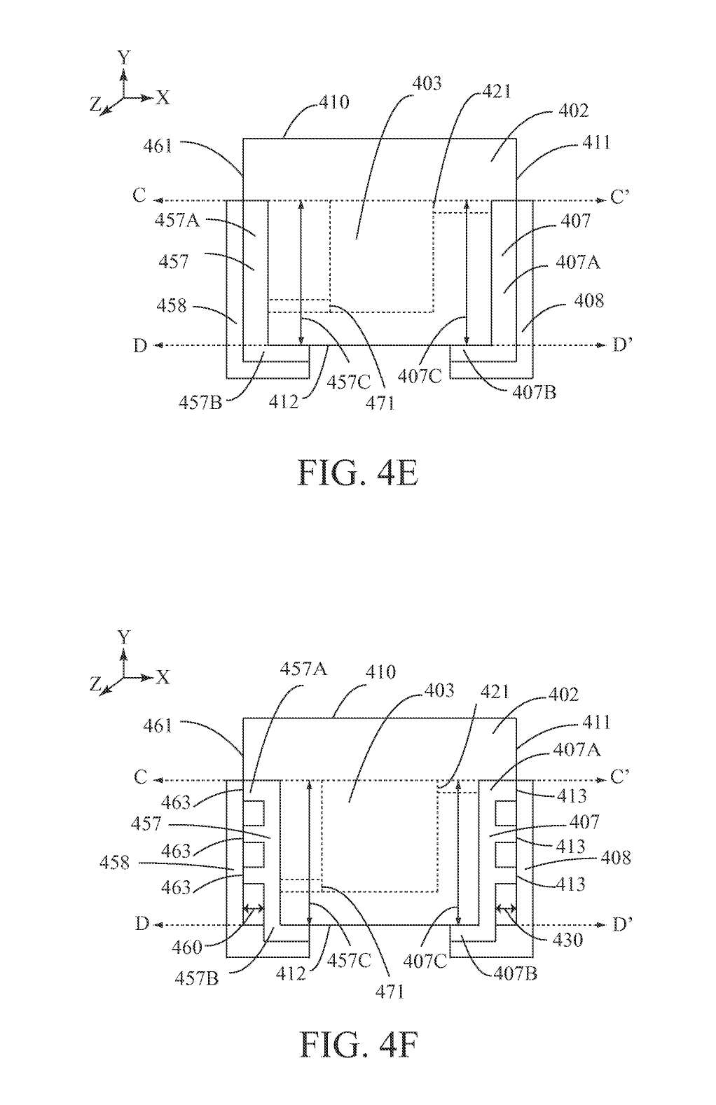

FIG. 4A illustrates a schematic XY-plane cross-sectional view of the structure 400 of the package structure with a first electrode and a second electrode. The structure 400 can be also a substrate-less package structure similar to the structure 200 in FIG. 2. In FIG. 4A, the package structure 400 comprises a conductive element 403, a body 402, a first electrode 407 and a second electrode 457. The body has a top surface 410, a bottom surface 412, a first lateral surface 411 and a second lateral surface 461.

The first lateral surface 411 has a first height 311X and a first width 411Y, and the second lateral surface 461 has a second height 461X and a second width 461Y. The top of the first electrode 407 and the top of second electrode 457 are substantially aligned with line C-C′ and the bottom of the body 402 is substantially aligned with line D-D′. Optionally, the top of the first electrode 407 and the top of second electrode 457 are not in the same horizontal level. The first electrode 407 has a first segment 407A and a second segment 407B electrically connecting to the first segment 407A, and the second electrode 457 has a third segment 457A and a fourth segment 457B electrically connecting to the third segment 457A. The first segment 407A has a height 407C, and the second segment 457A has a height 457C. Compared to the structure 200 in FIG. 2, the structure 400 has the first segment 407A of the first electrode 407 and the third segment 457A of the second electrode 457 substantially in the body 402. In one embodiment, one edge of the first segment 407A of the first electrode 407 is aligned with the first lateral surface 411 of the body 402, and one edge of the third segment 457A of the second electrode 457 is aligned with the second lateral surface 461 of the body 402 (see FIG. 4A). In another embodiment, the first segment 407A of the first electrode 407 is separated from the first lateral surface 411 of the body 402 by a first distance 430, and the third segment 457A of the second electrode 457 is separated from the second lateral surface 461 of the body 402 by a second distance 460. (see FIG. 4B). Preferably, the first distance 430 and the second distance 460 can be small. The conductive element 403 has a first terminal 421 and a second terminal 471 electrically connected to the first electrode 407 and the second electrode 457 respectively. Preferably, the first terminal 421 is electrically connected to the top of the first electrode 407 and the second terminal 471 is electrically connected to the bottom of the second electrode 457. In one embodiment, the first terminal 421 is electrically connected to the top of the first electrode 407 and the second terminal 471 is electrically connected to the suitable location of the second electrode 457.

FIG. 4C illustrates a schematic YZ-plane cross-sectional view of the structure 400 of the package structure with a first electrode and a second electrode. FIG. 4D illustrates a schematic YZ-plane cross-sectional view of the structure 400 of the package structure with a first electrode and a second electrode in a preferred embodiment. The first lateral surface 411 of the body 402 comprises at least one first opening 413 thereon, and the second lateral surface 461 of the body 402 comprises at least one second opening 463 thereon. The first opening 413 can be well-designed and is routed form line A-A′ to line B-B′, and the second opening 463 can be well-designed and is routed from line C-C′ to line D-D′. At least one portion of the first segment 407A is exposed to the first lateral surface 411 of the body 402 via the first opening 413, and at least one portion of the third segment 457A is exposed to the second lateral surface 461 of the body 402 via the second opening 463.

There are many ways to improve the yield of soldering of the first electrode 407 and the second electrode 457 in SMT process. For example, the area of the first opening 413 is substantially at least one-third the projection area of the first segment 407A on the first lateral surface 411; the area of the second opening 463 is substantially at least one-third the projection area of the third segment 457A on the second lateral surface 461. For example, the area of the first opening 413 is substantially at least one-third that of the first lateral surface 411; the area of the second opening 463 is substantially at least one-third that of the second lateral surface 461. For example, the first height 407C of the first segment 407A is substantially at least one-third the height 411X of the first lateral surface 411; the second height 457C of the third segment 457A is substantially at least one-third the height 461X of the second lateral surface 411. For example, the area of the first opening 413 is less than that of the first lateral surface 411 between line A-A′ and line B-B′, and the area of the second opening 463 is less than of the second lateral surface 461 between line C-C′ and line D-D′. Preferably, the first lateral surface 411 of the body 402 comprises at least one first opening 413 thereon (see FIG. 4D, e.g., a small first opening is disposed between the extending portions of a big first opening to increase opening density.); the second lateral surface 461 of the body 402 comprises at least one second opening 463 thereon (see FIG. 4D, e.g., a small second opening is disposed between the extending portions of a big second opening to increase opening density.)

Above characteristics described in FIG. 2, such as material or process, can be applied to the structure 400 in FIG. 4A.

The first opening 413 and the second opening 463 can have any suitable shapes for improving the yield of soldering of the first electrode 407 and the second electrode 457 in SMT process. The shapes of the first opening 413 and the second opening 463 depend on the layout designed by the designer, and it will be described hereafter. Preferably, the first opening 413 and the second opening 463 are zigzag-shaped.

Please refer to FIG. 4E and FIG. 4F. The first electrode 407 is electrically connected to the first pad 408 via the first opening 413 by soldering, and the second electrode 457 is electrically connected to the second pad 458 via the second opening 463 by soldering. The first electrode 407 and the second electrode 457 can be made of a first material (e.g., Cu) and the first pad 408 and the second pad 458 can be made of a second material (e.g., Sn). In the preferred embodiment, the first electrode 407 can be a first L-shaped electrode and the second electrode 457 can be a second L-shaped electrode. The first L-shaped electrode 407 has a first segment 407A and a second segment 407B electrically connecting to the first segment 407A, and the second L-shaped electrode 457 has a third segment 457A and a fourth segment 457B electrically connecting to the third segment 457A. The first segment 407A of the first electrode 407 is substantially disposed in the body 402 and the second segment 407B of the first electrode 407 is substantially on the bottom surface 412 of the body 402; The third segment 457A of the second electrode 457 is substantially disposed in the body 402 and the fourth segment 457B of the second electrode 457 is substantially on the bottom surface 412 of the body 402. The first pad 408 can be a first L-shaped pad for soldering process, and the second pad 458 can be a second L-shaped pad for soldering process.

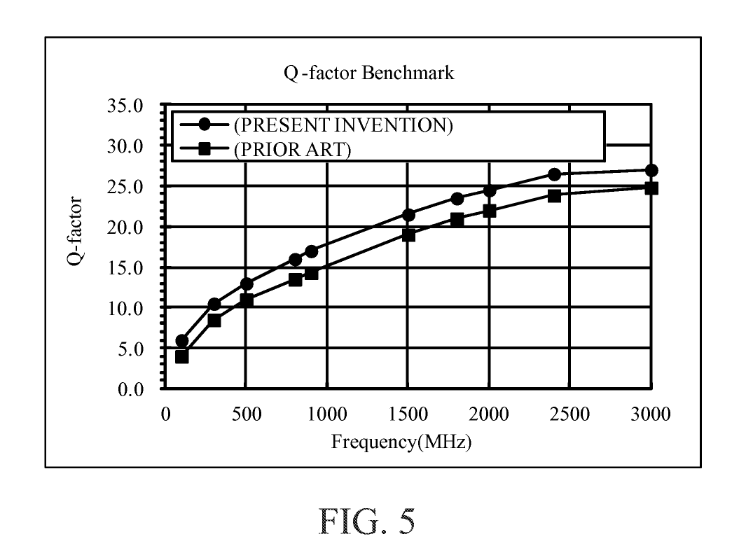

FIG. 5 is a graph showing Q factor versus frequency in the present invention compared with that in the prior art. The filled circles shown in FIG. 5 indicate Q factor versus frequency of the conductive element (e.g., a coil or an inductor) in the present invention. The filled squares shown in the FIG. 5 indicate Q factor versus frequency of a conventional conductive element (e.g., a coil or an inductor) in the prior art. FIG. 5 shows the improvement of Q-factor in the present invention, by approximately 10%, compared to the conventional conductive element.

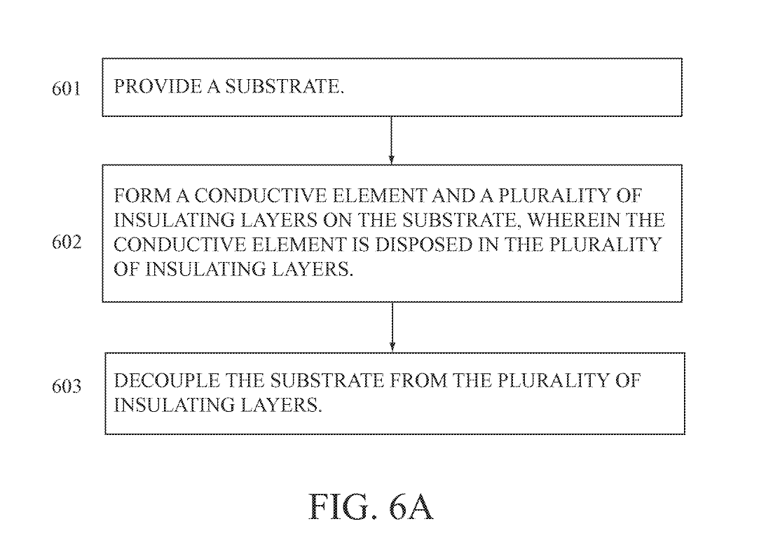

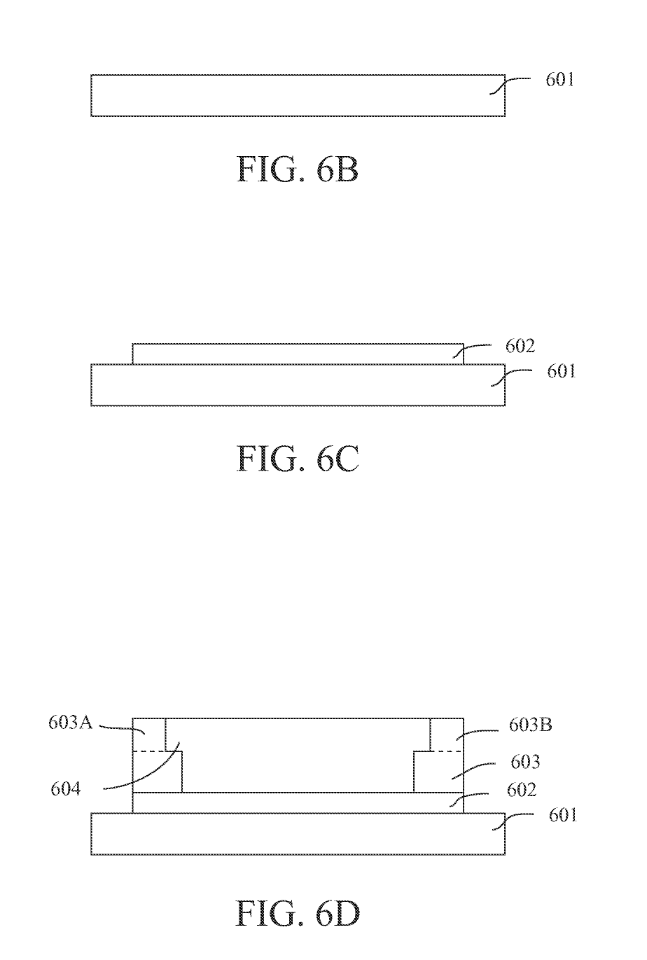

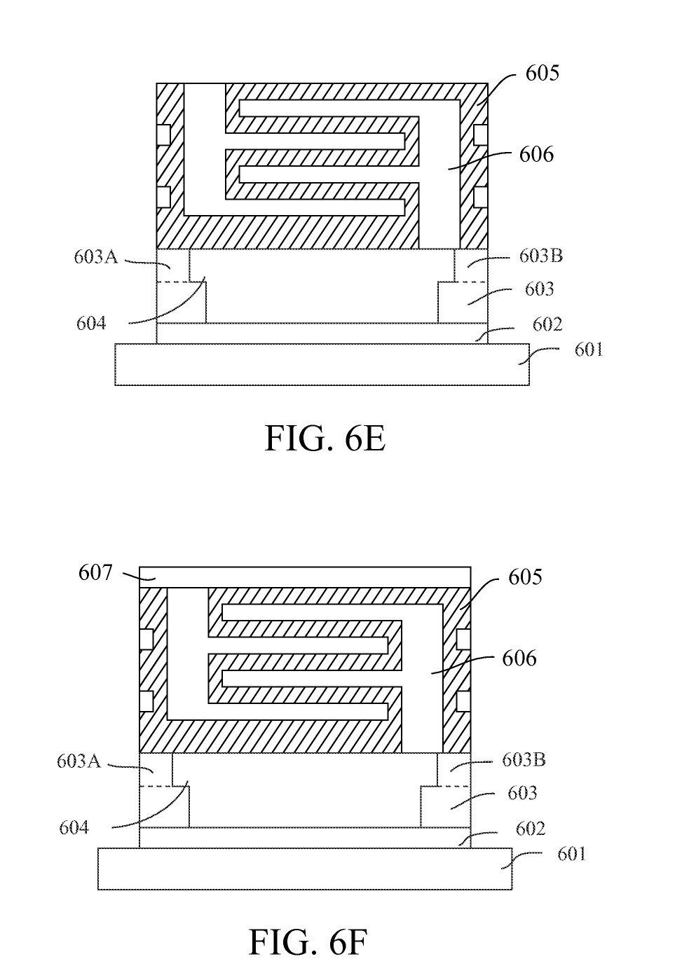

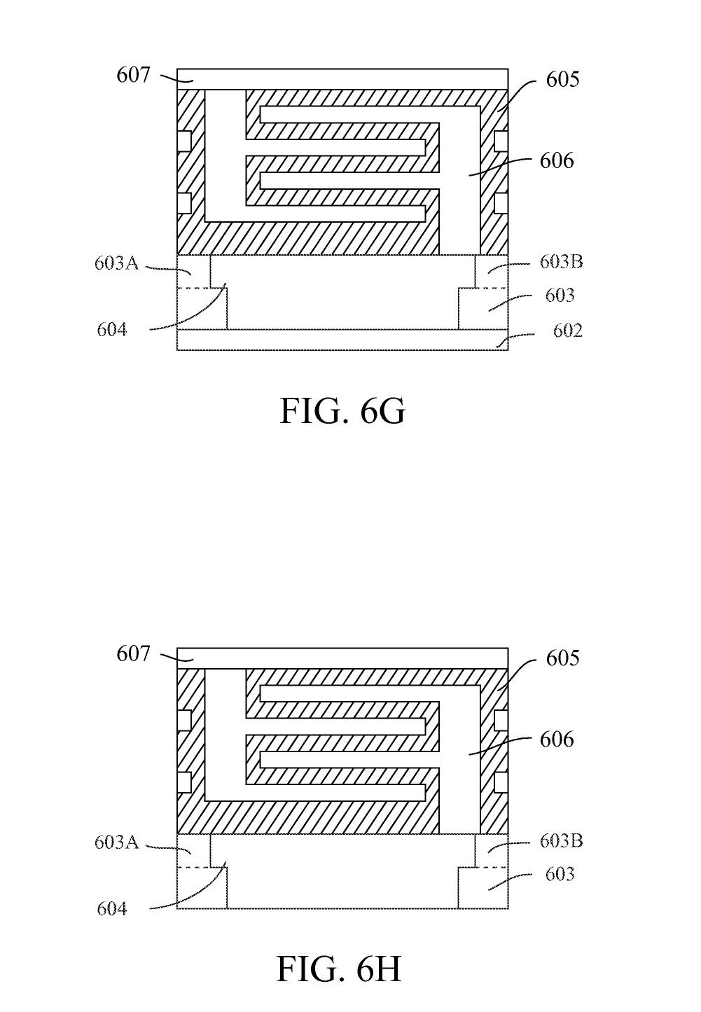

The present invention discloses a film process, such as lithography process, etching process or thin-film process, for manufacturing a substrate-less electronic component. By performing film process, the size of the electronic component can be smaller and more precise. FIG. 6A illustrates the process flow of manufacturing the structure 200 in FIG. 2, the structure 300 in FIG. 3A and the structure 400 in FIG. 4A.

Step 601: provide a substrate. The surface of the substrate can be flat enough to suffer from subsequent process applied to the substrate. In the preferred embodiment, the substrate can be made of a glass material. In one embodiment, a buffer layer can be formed on the substrate. The buffer layer is a temporary layer for bonding the substrate and the layers in order to process or pattern the layers on the substrate. After the process is done, the buffer layer can be easily removed to decouple the glass substrate from the layers.

Step 602: form a conductive element and a plurality of insulating layers on the substrate, wherein the conductive element is disposed in the plurality of insulating layers. The conductive element is manufactured by performing a sequence of film process on each of the conductive layers. By performing film process, a slim electronic component can be easily manufactured with a optional thickness (e.g., variable number of the conductive layers).

Step 603: decouple the substrate from the plurality of insulating layers. After conductive element is finished on the substrate, the substrate can be easily decoupled from the plurality of insulating layers. Compared to the ceramic substrate with bigger hardness used in the LTCC process, the electronic component is substrate-less and its thickness is smaller so that it's convenient to trim. Because all processed layers are easily separated by the buffer layer, the substrate can be easily decoupled from all processed layers after all layers are processed on the substrate. In one embodiment, the buffer layer can be also decoupled from the plurality of insulating layers.

FIG. 6B to FIG. 6H illustrate the process flow for manufacturing the structure 400 in FIG. 4A in detail. The process flow can also be applied to the structure 200 in FIG. 2 and the structure 300 in FIG. 3A, but it's not described in detail herein.

As illustrated In FIG. 6B, a substrate 601 is provided. The substrate 601 can be a glass substrate or any flat substrate. As illustrated In FIG. 6C, a buffer layer 602 is formed on the substrate 601. The function of the buffer layer 602 has been described in step 601, 602, 603 of FIG. 6A.

As illustrated In FIG. 6D, a first conductive layer 603 is formed which has a first portion 603A and a second portion 603B above the buffer layer 602. The first conductive layer 603 can comprise at least two first sub-layers. Then, a first insulating layer 604 is formed between the first portion 603A and the second portion 603B. The first insulating layer 604 can be also disposed on the buffer layer 602. In one embodiment, the first portion 603A and the second portion 603B can be disposed on opposite edges of the buffer layer 602. A portion of each of the first portion 603A and the second portion 603B can be also disposed beyond the edge of the buffer layer 602. The first portion 603A and the second portion 603B can be portions of the first electrode 407 and the second electrode 457 respectively.

As illustrated In FIG. 6E, a plurality of second conductive layers 605 and a plurality of second insulating layers 606 are formed, wherein the second conductive layers 605 are electrically connected to the first portion 603A and the second portion 603B. A first conductive layer 603 and the plurality of second conductive layers 605 constitute the package structure 400 comprising the conductive element 403, the first electrode 407 and the second electrode 457. The second insulating layers 606 are disposed between the adjacent second conductive layers 605.

As illustrated In FIG. 6F. A third insulating layer 607 is formed on the plurality of second conductive layers 605 and a plurality of second insulating layers 606. As illustrated In FIG. 6G, the substrate 601 is removed from the package structure 400. As illustrated In FIG. 6H, the buffer layer 602 is removed from the package structure 400 (an optional step). In one embodiment, at least one recess can be formed on the lateral surface of the package structure 400 for the configuration of the electrodes.

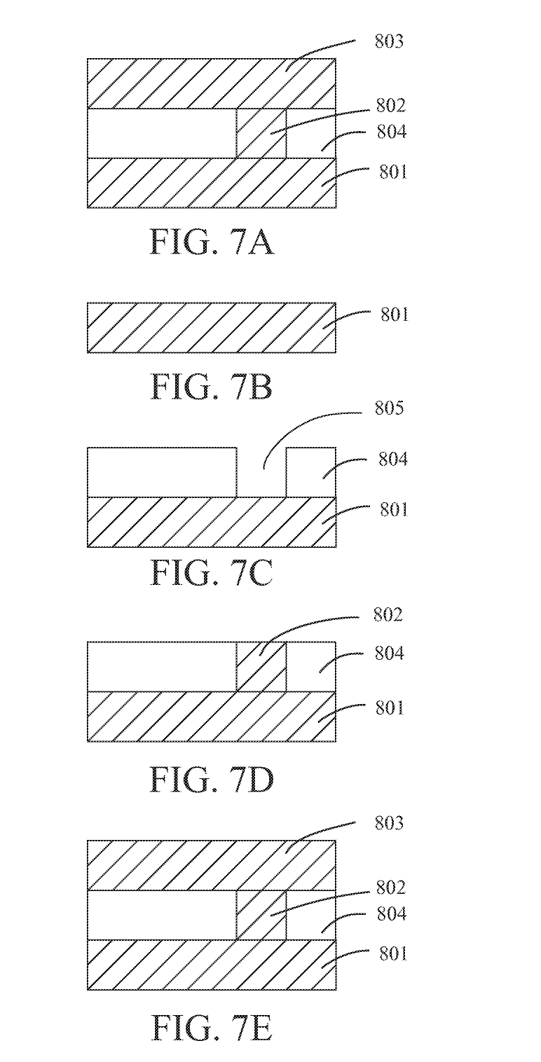

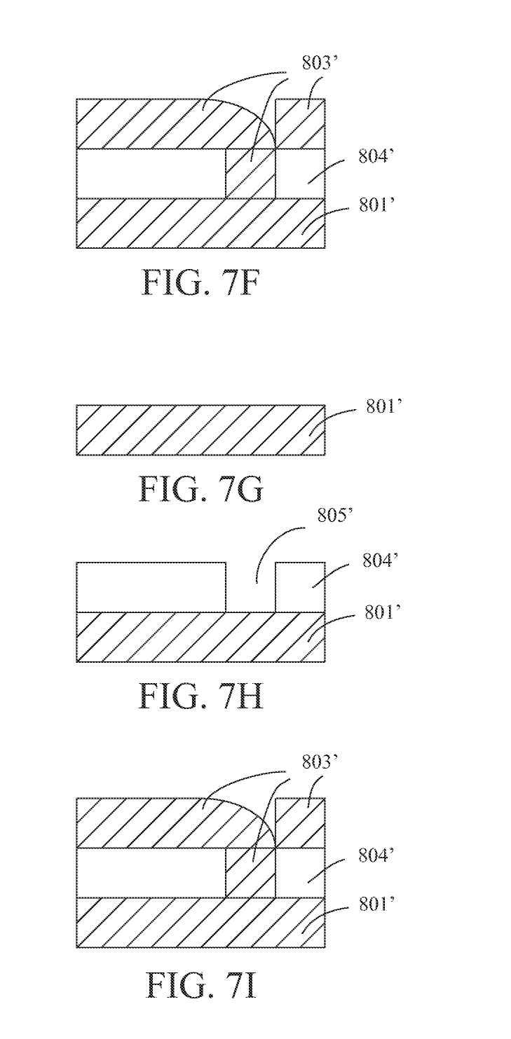

Generally (see FIG. 7A), for the electrical connection of the adjacent conductive layers 801, 803, the adjacent conductive layers 801, 803 need a via layer 802 (e.g., metallic via layer) therebetween, wherein the via layer 802 is formed in a dielectric layer 804. A sequence of processes are needed to be performed to make the structure in FIG. 7A, and the processes include the following steps: a. provide a first conductive layer 801 (see FIG. 7B); b. form a first insulating layer 804 which has a through-hole 805 therein (see FIG. 7C); c. form a via layer 802 in the through-hole 805 (see FIG. 7D); d form a second conductive layer 803 on the via layer 802 and the first insulating layer 804 (see FIG. 7E).

A stacking structure for the electrical connection of the adjacent conductive layers (see FIG. 7F) and the manufacturing method thereof which omits a step compared to the sequence of processes to make the structure in FIG. 7A can be used repeatedly in

the present invention. The manufacturing method includes the following steps: a. provide a first conductive layer 801′ (see FIG. 7G); b. form a first insulating layer 804′ which has a through-hole 805′ therein (see FIG. 7H); c. form a second conductive layer 803′ in the through-hole 805′ and the first insulating layer 804′ (see FIG. 7I).

The second conductive layer 803′ can be formed non-horizontally or stacked non-horizontally. The top surface of a portion of the second conductive layer 803′ in the through-hole 805′ is lower than that of a portion of the second conductive layer 803′ on the first insulating layer 804′. The second conductive layer 803′ can be formed by any suitable process. Preferably, the diameter of the through-hole 805′ increases from the bottom of the through-hole 805′ to the top of the through-hole 805′ so that the second conductive layer 803′ can be formed in the non-horizontal direction smoothly by film process.

In the following embodiments, only M2-stacking-structure, M3-stacking-structure, and M4-stacking-structure are described. The applications of the stacking structure in the present invention can be extended to a repeated stacking structure, such as M5-stacking-structure or M6-stacking-structure, in a similar way so that it's not described herein.

For convenience of explanation, the M2-stacking-structure in FIG. 8C, the M3-stacking-structure in FIG. 8D and the M4-stacking-structure in FIG. 8D are simplified, but each of them has a stacking structure the same as that in FIG. 8A or FIG. 8B.

### M2-Stacking-Structure

FIG. 8A illustrates a schematic cross-sectional view of the ideal stacking structure 900A for the electrical connection of the adjacent conductive layers. The structure 900 includes a first insulating layer 901, a first conductive layer 902, a second insulating layer 903 and a second conductive layer 904. The first insulating layer 901 has a first through-hole 901A. The first conductive layer 902 is disposed on the first insulating layer 901, wherein the first conductive layer 902 has a first connection portion 902A and a second connection portion 902B, wherein the first connection portion 902A is disposed in the first through-hole 901A. The second insulating layer 903 is disposed on the first conductive layer 902, wherein the second insulating layer 903 has a second through-hole 903A located on the second connection portion 902B of the first conductive layer 902. The second conductive layer 904 is disposed on the second insulating layer 903, wherein the second conductive layer 904 has a third connection portion 904A and a fourth connection portion 904B, wherein the third connection portion 904A of the second conductive layer 904 is disposed in the second through-hole 903A and is electrically connected to the second connection portion 902B of the first conductive layer 902. In one embodiment, each of the first conductive layer 902 and the second conductive layer 904 can be a strip-like pattern. In one embodiment, a third insulating layer (not shown) is disposed on the second conductive layer 904.

FIG. 8B illustrates a schematic cross-sectional view of the real stacking structure 900B for the electrical connection of the adjacent conductive layers in the preferred embodiment. Compared to the stacking structure 900A in FIG. 8A, the first insulating layer 901 has a first portion 901M and a second portion 901N abutting two sides of the first through-hole 901A respectively, and the first conductive layer 902 is disposed on first portion 901M and a second portion 901N of the first insulating layer 901; the third insulating layer 903 has a third portion 903M and a fourth portion 903N abutting two sides of the second through-hole 903A respectively, and the second conductive layer 904 is disposed on third portion 903M and a fourth portion 903N of the second insulating layer 903. The stacking structure 900B depends on the designed layout to further improve process. For example, if the cross-section of the stacking structure 900B is exposed, the density of the opening filled with the conductive material can increase to improve the yield in SMT process (described previously in FIG. 3C).

Each of the first insulating layer 901, the second insulating layer 903 and the third insulating layer (not shown) can comprise at least one of epoxy, oxide, a polymer-based material or a magnetic material. Each of the first conductive layer 902 and the second conductive layer 904 can comprise at least one of Cu, Ag, or any other suitable metallic material.

FIG. 8C illustrates a schematic cross-sectional view of the simplified stacking structure 900C for the electrical connection of the adjacent conductive layers. Compared to the ideal stacking structure 900A in FIG. 8A, an angle 904Z is formed by the intersection of the boundary M-M′ of the adjacent layers (e.g., the second insulating layer 903 and the second conductive layer 904) and the horizontal line N-N′. In other words, the conductive layer (e.g., the second conductive layer 904) substantially extends in a non-horizontal direction. Besides, the diameters of the first through-hole 901A and the second through-hole 903A can be not uniform, and they preferably increase from the bottom of the through-hole to the top of the through-hole. In the preferred embodiment, the first conductive layer 902 extends in a first direction 902X and the second conductive layer 904 extends in a second direction 904X, wherein the first direction 902X and the second direction 904X are substantially coplanar (similar to two vectors in a plane mathematically, described in detail hereafter). In other words, the first conductive layer 902 and the second conductive layer 904 are substantially vertically-aligned. In one embodiment, the horizontal component 902Y of the first direction 902X is substantially opposite to the horizontal component 904Y of the second direction 904X. In one embodiment, the first connection portion 902A and the second connection portion 902B of the first conductive layer 902 are respectively a first connection end and a second connection end of the first conductive layer 902. The third connection portion 904A and the fourth connection portion 904B of the second conductive layer 904 are respectively a third connection end and a fourth connection end of the second conductive layer 904.

### M3-Stacking-Structure

FIG. 8D illustrates a schematic cross-sectional view of the simplified stacking structure 900D in another embodiment for the electrical connection of the adjacent conductive layers. Compared to the actual stacking structure 900C in FIG. 8C, the difference is listed as below: a third insulating layer 905 is disposed on the second conductive layer 904, wherein the third insulating layer 905 has a third through-hole 905A located on the fourth connection portion 904B of the second conductive layer 904; a third conductive layer 906 is disposed on the third insulating layer 905, wherein the third conductive layer 906 has a fifth connection portion 906A and a sixth connection portion 906B, wherein the fifth connection portion 906A of the third conductive layer 906 is disposed in the third through-hole 905A and is electrically connected to the fourth connection portion 904B of the second conductive layer 904. In one embodiment, each of the first conductive layer 902, the second conductive layer 904 and the third conductive layer 906 can be a strip-like pattern. In one embodiment, a fourth insulating layer (not shown) is disposed on the third conductive layer 906.

Each of the first insulating layer 901, the second insulating layer 903, the third insulating layer 905 and the fourth insulating layer (not shown) can comprise at least one of epoxy, oxide, a polymer-based material or a magnetic material. Each of the first conductive layer 902, the second conductive layer 904 and the third conductive layer 906 can comprise at least one of Cu, Ag, or any other suitable metallic material.

An angle 904Z is formed by the intersection of the boundary M-M′ of the adjacent layers (e.g., the third insulating layer 905 and the third conductive layer 906) and the horizontal line N-N′. In other words, the conductive layer (e.g., the third conductive layer 906) substantially extends in a non-horizontal direction. Besides, the diameter of each of the first through-hole 901A, the second through-hole 903A and the third through-hole 905A can be not uniform, preferably increases form the bottom of the through-hole to the top of the through-hole. In the preferred embodiment, the first conductive layer 902 extends in a first direction 902X, the second conductive layer 904 extends in a second direction 904X, and the third conductive layer 906 extends in a third direction 906X, wherein the first direction 902X, the second direction 904X and the third direction 906X is substantially coplanar (similar to three vectors in a plane mathematically, described in detail hereafter). In other words, the first conductive layer 902, the second conductive layer 904 and the third conductive layer 906 are substantially vertically-aligned. In one embodiment, the horizontal component 902Y of the first direction 902X is substantially opposite to the horizontal component 904Y of the second direction 904X, and the horizontal component 904Y of the second direction 904X is substantially opposite to the horizontal component 906Y of the third direction 906X. In one embodiment, the first connection portion 902A and the second connection portion 902B of the first conductive layer 902 are respectively a first connection end and a second connection end of the first conductive layer 902. The third connection portion 904A and the fourth connection portion 904B of the second conductive layer 904 are respectively a third connection end and a fourth connection end of the second conductive layer 904. The fifth connection portion 906A and the sixth connection portion 906B of the third conductive layer 904 are respectively a fifth connection end and a sixth connection end of the third conductive layer 906.

In a preferred embodiment, the first connection portion 902A of the first conductive layer 902, the fourth connection portion 904B of the second conductive layer 904 and the fifth connection portion 906A of the third conductive layer 906 are substantially collinear, preferably vertically collinear (described in detail hereafter). The second connection portion 902B of the first conductive layer 902, the third connection portion 904A of the second conductive layer 904 and the sixth connection portion 906B of the third conductive layer 906 are substantially collinear, preferably vertically collinear (described in detail hereafter).

### M4-Stacking-Structure

FIG. 8E illustrates a schematic cross-sectional view of the simplified stacking structure 900E in yet another embodiment for the electrical connection of the adjacent conductive layers. Compared to the actual stacking structure 900D in FIG. 8D, the difference is listed as below: a fourth insulating layer 907 is disposed on the third conductive layer 906, wherein the fourth insulating layer 907 has a fourth through-hole 907A located on the sixth connection portion 906B of the third conductive layer 906; a fourth conductive layer 908 is disposed on the fourth insulating layer 907, wherein the fourth conductive layer 908 has a seventh connection portion 908A and an eighth connection portion 908B, wherein the seventh connection portion 908A of the fourth conductive layer 908 is disposed in the fourth through-hole 907A and is electrically connected to the sixth connection portion 906B of the third conductive layer 906. In one embodiment, each of the first conductive layer 902, the second conductive layer 904, the third conductive layer 906 and the fourth conductive layer 908 can be a strip-like pattern. In one embodiment, a fifth insulating layer (not shown) is disposed on the fourth conductive layer 908.

Each of the first insulating layer 901, the second insulating layer 903, the third insulating layer 905, the fourth insulating layer 907 and the fifth insulating layer (not shown) can comprise at least one of epoxy, oxide, a polymer-based material or a magnetic material. Each of the first conductive layer 902, the second conductive layer 904, the third conductive layer 906 and the fourth conductive layer 908 can comprise at least one of Cu, Ag, or any other suitable metallic material.

An angle 904Z is formed by the intersection of the boundary M-M′ of the adjacent layers (e.g., the fourth insulating layer 907 and the fourth conductive layer 908) and the horizontal line N-N′. In other words, the direction in which the conductive layer (e.g., the fourth conductive layer 908) substantially extends in a non-horizontal direction. Besides, the diameter of each of the first through-hole 901A, the second through-hole 903A, the third through-hole 905A and the fourth through-hole 907A can be not uniform, preferably increases form the bottom of the through-hole to the top of the through-hole. In the preferred embodiment, the first conductive layer 902 extends in a first direction 902X, the second conductive layer 904 extends in a second direction 904X, the third conductive layer 906 extends in a third direction 906X, and the fourth conductive layer 908 extends in a fourth direction 908X, wherein the first direction 902X, the second direction 904X, the third direction 906X and the fourth direction 908X is substantially coplanar (similar to four vectors in a plane mathematically, described in detail hereafter). In other words, the first conductive layer 902, the second conductive layer 904, the third conductive layer 906 and the fourth conductive layer 908 are substantially vertically-aligned. In one embodiment, the horizontal component 902Y of the first direction 902X is substantially opposite to the horizontal component 904Y of the second direction 904X, the horizontal component 904Y of the second direction 904X is substantially opposite to the horizontal component 906Y of the third direction 906X, and the horizontal component 906Y of the third direction 906X is substantially opposite to the horizontal component 908Y of the fourth direction 906X. In one embodiment, the first connection portion 902A and the second connection portion 902B of the first conductive layer 902 are respectively a first connection end and a second connection end of the first conductive layer 902. The third connection portion 904A and the fourth connection portion 904B of the second conductive layer 904 are respectively a third connection end and a fourth connection end of the second conductive layer 904. The fifth connection portion 906A and the sixth connection portion 906B of the third conductive layer 904 are respectively a fifth connection end and a sixth connection end of the third conductive layer 906. The seventh connection portion 908A and the fourth connection portion 908B of the fourth conductive layer 908 are respectively a seventh connection end and an eight connection end of the fourth conductive layer 908.

In a preferred embodiment, the first connection portion 902A of the first conductive layer 902, the fourth connection portion 904B of the second conductive layer 904, the fifth connection portion 906A of the third conductive layer 906 and the eight connection portion 908B of the fourth conductive layer 908 are substantially collinear, preferably vertically collinear (described in detail hereafter). The second connection portion 902B of the first conductive layer 902, the third connection portion 904A of the second conductive layer 904, the sixth connection portion 906B of the third conductive layer 906 and the seventh connection portion 908A of the fourth conductive layer 908 are collinear, preferably vertically collinear (described in detail hereafter).

The M2-stacking-structure in FIG. 8C, the M3-stacking-structure in FIG. 8D, the M4-stacking-structure in FIG. 8E or a repeated structure can be used in a package structure of the present invention. Take the M4-stacking-structure in FIG. 8E and refer to FIG. 8F. A stacking structure comprises a substrate 1001 and a plurality of conductive layers 902, 904, 906, 908. The substrate 1001 has a first lateral surface 1002 and a second lateral surface 1003 opposite to the first lateral surface 1002. The substrate can be made of a plurality of insulating layers, such as PCB. The plurality of conductive layers disposed in the substrate 1001, wherein each two adjacent layers of the plurality of conductive layers are contacted each other in a contact region, wherein the contact regions of the plurality of conductive layers are interleaved along the first lateral surface 1002 and the second lateral surface 1003. For example, the first conductive layer 902 and the second conductive layer 904 are contacted each other in a first contact region 902B, 904A; the second conductive layer 904 and the third conductive layer 906 are contacted each other in a second contact region 904B, 906A; the third conductive layer 906 and the fourth conductive layer 908 are contacted each other in a third contact region 906B, 908A. The first contact region 902B, 904A and the third contact region 906B, 908A are close to first lateral surface 1002, and the second contact region 904B, 906A is close to second lateral surface 1003. The first contact region 902B, 904A, the second contact region 904B, 906A and the third contact region 906B are disposed in a first plane (e.g., A₁A₂A₃A₄-plane in FIG. 11A) perpendicular to the bottom surface 1004 of the substrate 1001. The first conductive layer 902 and the second conductive layer 904 substantially extend in a first non-horizontal direction 902X, 906X; the second conductive layer 904 and the fourth conductive layer 908 substantially extend in a second non-horizontal direction 904X, 908X.

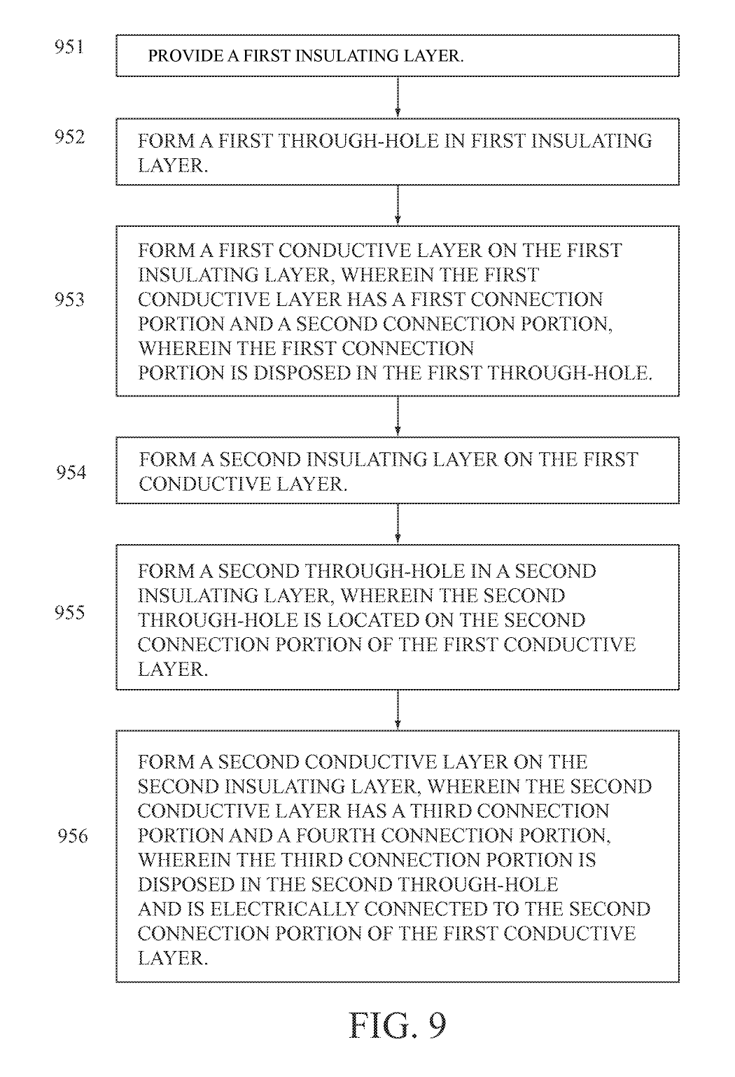

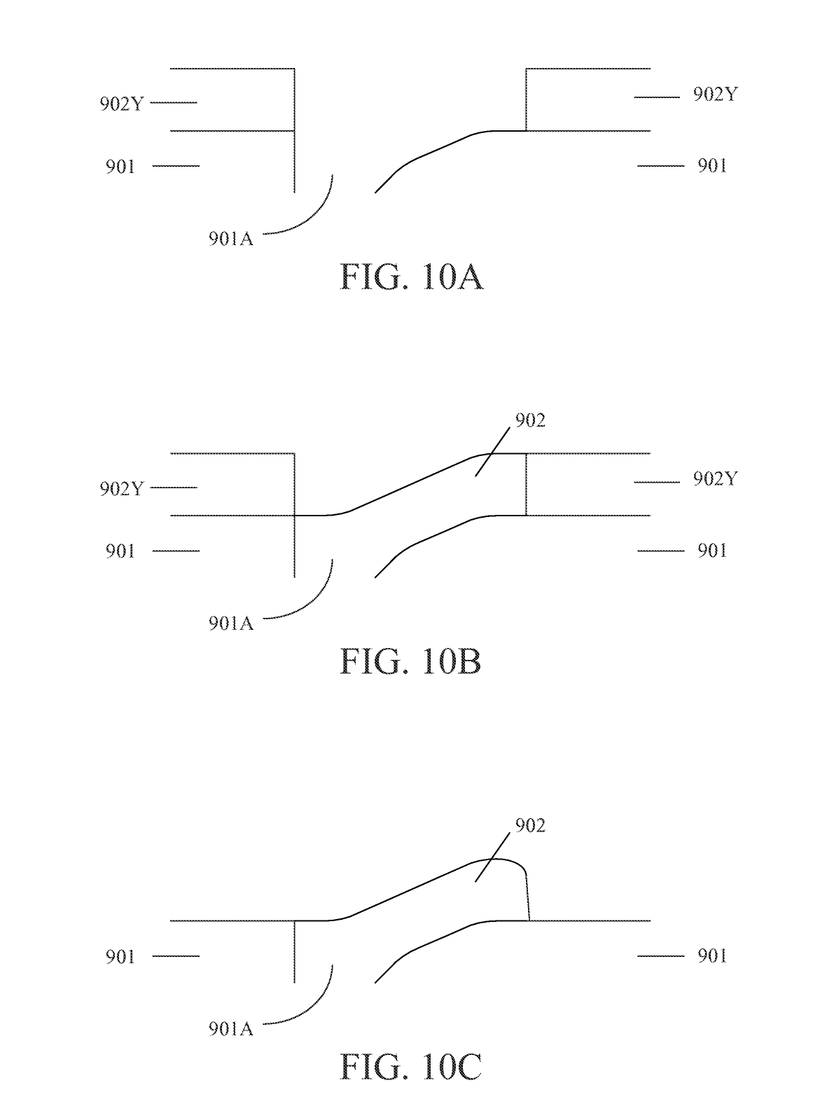

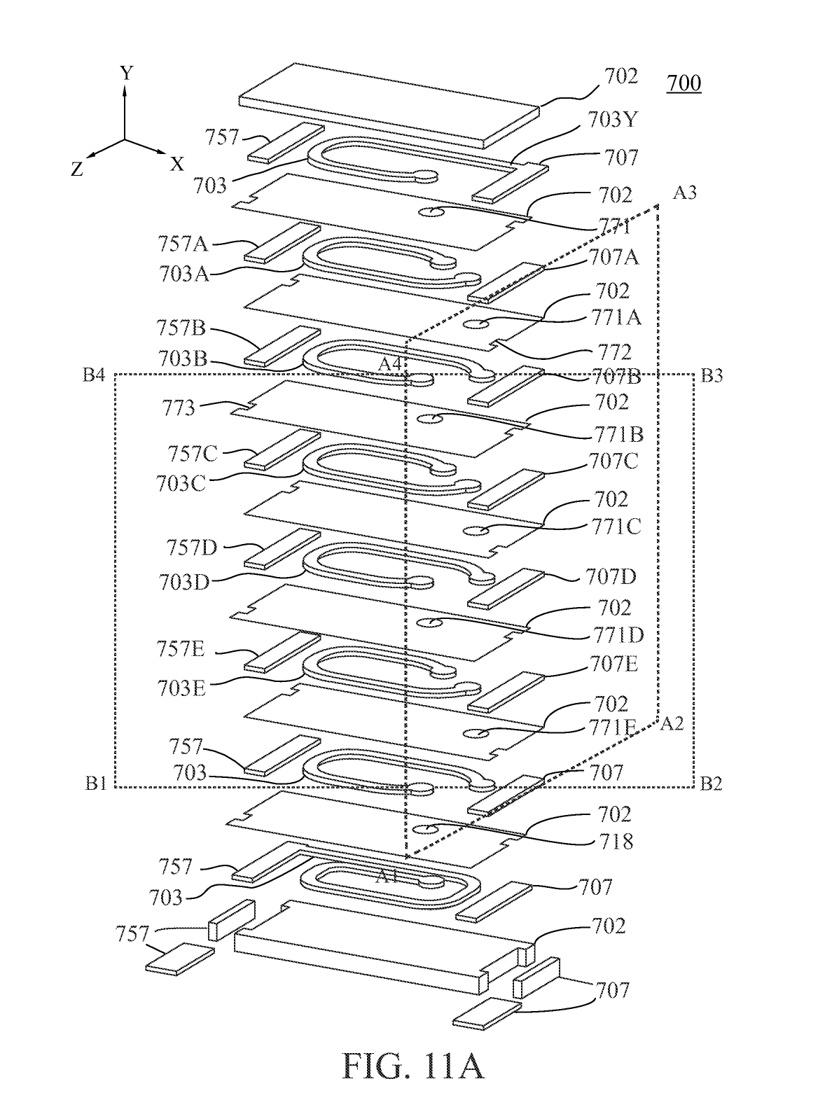

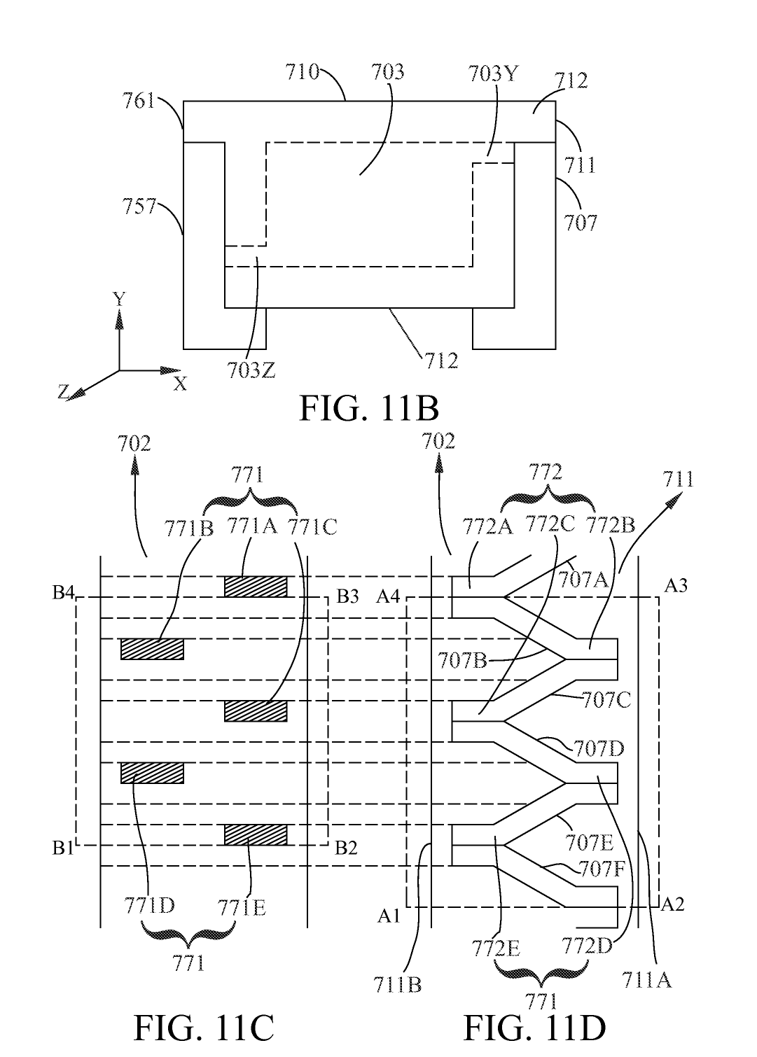

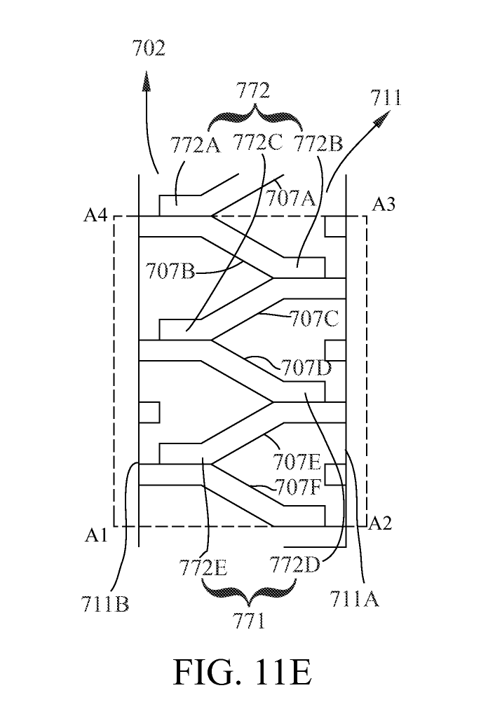

FIG. 9 illustrates a process flow of a method for manufacturing the structure 900C in FIG. 8C in the present invention. In one embodiment, the conductive layer or the insulating layer can be patterned non-horizontally or stacked non-horizontally by any suitable process.

In step 951, provide a first insulating layer 901. In step 952, form a first through-hole 901A in first insulating layer 901. The diameter of the first through-hole 901A can be not uniform, preferably increases form the bottom of the through-hole to the top of the through-hole. In step 953, form a first conductive layer 902 on the first insulating layer 901, wherein the first conductive layer 902 has a first connection portion 902A and a second connection portion 902B, wherein the first connection portion 902A is disposed in the first through-hole 901A. Because the diameter of the first through-hole 901A is preferably not uniform, the first conductive layer 902 can be formed in the first direction 902X described previously in FIG. 8C. The first conductive layer 902 can be patterned by any suitable process. For example (but not limited to this example), after the first through-hole 901 A is formed in first insulating layer 901, a photoresist layer 902Y can be patterned (e.g., exposure, development) on a portion of first insulating layer 901 to expose the first through-hole 901A in first insulating layer 901 (see FIG. 10A). Optionally, a thin conductive layer (not shown) can be formed on the first insulating layer 901 in advance for facilitating the subsequent the deposition of the first conductive layer 902. Then, the first conductive layer 902 can be deposited on the exposed portions of the first insulating layer 901 uncovered with the photoresist layer 902Y by any suitable process (see FIG. 10B), such as Cu electroplating. Finally, the photoresist layer 902Y is removed on the portion of the first insulating layer 901 (see FIG. 10C). The top of first conductive layer 902 can be higher than the top of first insulating layer 901.

In step 954, form a second insulating layer 903 on the first conductive layer 902. The second insulating layer 903 can be formed on the second insulating layer 903 wherein the top of second insulating layer 903 is in the same horizontal level. Optionally, the second insulating layer 903 can be formed on the second insulating layer 903, wherein the top of second insulating layer 903 is not in the same horizontal level (e.g., conformally). In step 955, form a second through-hole 903A in a second insulating layer 903, wherein the second through-hole 903A is located on the second connection portion 902B of the first conductive layer 902. In other words, the second connection portion 902B of the first conductive layer is 902 exposed. In step 956, form a second conductive layer 904 on the second insulating layer 903, wherein the second conductive layer 904 has a third connection portion 904A and a fourth connection portion 904B, wherein the third connection portion 904A is disposed in the second through-hole 903A and is electrically connected to the second connection portion 902B of the first conductive layer 902. The second conductive layer 904 can be patterned by any suitable process, such as the process described previously in step 953. In one embodiment, a third insulating layer 905 is formed on the second conductive layer 904.

For the process flow of a method for manufacturing the structure 900D in FIG. 8D and the structure 900E in FIG. 8E, it is similar to the method for manufacturing the structure 900E in FIG. 8E, so that it is not described herein.

The preferred embodiment of the present invention discloses the stacking structures 900A, 900B, 900C, 900D, 900E for aligning a conductive element. The structure for aligning a conductive element has some advantages, e.g., non-complex process, low cost, better electrical properties. By repeating the processes in FIG. 7G to FIG. 7I, the number of the processed layers used in the stacking structure of the present invention can be largely reduced. Preferably, the stacking structure 900A, 900B, 900C, 900D, 900E for aligning a conductive element is an electrode.

FIG. 11A illustrates all layout patterns in a package structure 700. FIG. 11B illustrates a schematic XY-plane cross-sectional view of the structure 700 of the package structure. The package structure 700 comprises a conductive element 703, a body 702, a first electrode 707 and a second electrode 757. The body 702 has a top surface 710, a bottom surface 712, a first lateral surface 711 and a second lateral surface 761. The conductive element 703 is disposed in the body 702. The conductive element 703 has a first terminal 703Y and a second terminal 703Z, and the conductive element 703 comprises a plurality of first conductive layers. The first electrode 707 is electrically connected to the first terminal 703Y of the conductive element 703, wherein the first electrode 707 comprises a plurality of second conductive layers. The second electrode 757 is electrically connected to the second terminal 703Z of the conductive element 703, wherein the second electrode 757 comprises a plurality of third conductive layers. The body 702 comprises a plurality of first insulating layers. The first insulating layers are disposed between the adjacent first conductive layers of the conductive element 703. The adjacent first conductive layers are connected to each other via the first through holes 771 in the first insulating layers. In one embodiment, the first insulating layers are disposed between the adjacent second conductive layers of the first electrode 707. The adjacent second conductive layers are connected to each other via second through holes 772 in the first insulating layers. In one embodiment, the first insulating layers are disposed between the adjacent third conductive layers of the second electrode 757. The adjacent third conductive layers are connected to each other via third through holes 773 in the first insulating layers.

FIG. 11C and FIG. 11D illustrate a schematic A₁A₂A₃A₄-plane cross-sectional view of the structure 700 and a schematic B₁B₂B₃B₄-plane cross-sectional view of the structure 700. A schematic B₁B₂B₃B₄-plane cross-sectional view of the preferred structure 700 is shown in FIG. 11E (similar to FIG. 8B), and the structure 700 depends on the designed layout to further improve process. For example, the density of the opening filled with the conductive material can increase to improve the yield in SMT process (described previously in FIG. 3C.)

In FIG. 11C and FIG. 11D, because the configuration of the first electrode 707 is similar to that of the second electrode 757, only the configuration of the first electrode 707 aligning the conductive element 703 is shown. In the preferred embodiment, one of the first conductive layers of the conductive element 703 corresponds to one of the second conductive layers of the first electrode 707 from the bottom of the body 702 to the top of the body 702. For example, the adjacent first conductive layers 703A, 703B are connected to each other via the first through hole 771A, the adjacent first conductive layers 703B, 703C are connected to each other via the first through hole 771B, and the first conductive layer 703B (e.g., a spiral pattern layer) between the first through holes 771A and 771B corresponds to the second conductive layer 707B; the adjacent first conductive layers 703C, 703D are connected to each other via the first through hole 771C, and the first conductive layer 703C (e.g., a spiral pattern layer) between the first through holes 771B and 771C corresponds to the second conductive layer 707C. In one embodiment, the second through holes 772A, 772C, and 772E are substantially disposed in a first line (772A-772C-772E), and the second through holes 772B, 772D are substantially disposed in a second line (772B-772D). In one embodiment, each of the first conductive layer 707C and the second conductive layer 707B can be a strip-like pattern. Each of the first conductive layer 707C and the second conductive layer 707B substantially extends in a non-horizontal direction. The first conductive layer 707C extends in a first direction and the second conductive layer 707B extends in a second direction, wherein the first direction and the second direction is substantially coplanar (e.g., A₁A₂A₃A₄-plane). In other words, the first conductive layer 707C and the second conductive layer 707B are substantially vertically-aligned (substantially overlap in Y direction). In one embodiment (see FIG. 8C to FIG. 8E), the horizontal component of the first direction is substantially opposite to the horizontal component of the second direction. The number of the first conductive layers of the conductive element 703 can be substantially the same as the number of the second conductive layers of the first electrode 707 for convenience of electrical connection between the first terminal 703Y of the conductive element 703 and the first electrode 707. However, if electrical connection between the first terminal 703Y of the conductive element 703 and the first electrode 707 can work, the number of the first conductive layers of the conductive element 703 can be different from the number of the second conductive layers of the first electrode 707.

In summary, the preferred embodiment of the present invention discloses a stacking structure 707 for aligning a conductive element 703. A stacking structure 707 comprises a first insulating layer, a first conductive pattern 707C, a second insulating layer, a second conductive pattern 707B, and the conductive element 703 comprising a first conductive layer 703C and a second conductive layer 703B on the first conductive layer 703C. The first insulating layer has a first through-hole 772C. The first conductive pattern 707C is disposed on the first insulating layer, wherein the first conductive pattern 707C has a first connection portion and a second connection portion, wherein the first connection portion is disposed in the first through-hole 772C, wherein the first conductive pattern 707C corresponds to the first conductive layer 703C. A second insulating layer is disposed on the first conductive pattern 707C, wherein the second insulating layer has a second through-hole 772B located on the second connection portion of the first conductive pattern 707C. A second conductive pattern 707B is disposed on the second insulating layer, wherein the second conductive pattern 707B has a third connection portion and a fourth connection portion, wherein the third connection portion of the second conductive pattern 707B is disposed in the second through-hole 772B and is electrically connected to the second connection portion of the first conductive pattern 707C, wherein the second conductive pattern 707B corresponds to the second conductive layer 703B.

There are many different ways to locate the first through-hole 772C and the second through-hole 772B. The first through-hole 772C can be formed inside the first insulating layer, and the second through-hole 772B can be formed inside the second insulating layer. Preferably, the first through-hole 772C can be formed with one side aligned with one edge of the first insulating layer, and the second through-hole 772B can be formed with one side aligned with one edge of the second insulating layer. The first through-hole 772C can be formed with two sides aligned with two edges of the first insulating layer, and the second through-hole 772B can be formed with two sides aligned with two edges of the second insulating layer.

Please refer back to FIG. 11C to FIG. 11D. In one embodiment, every three adjacent conductive layers in the second conductive layers of the first electrode 707 have a first connection and a second connection, and the first connection is near the first side 711A of the first lateral surface 711 and the second connection is near the second side 711B of the first lateral surface 711. For example, three adjacent conductive layers 707B, 707C, 707D have a first connection 772B and a second connection 772C, the first connection is near the first side 711A of the first lateral surface 711, and the second connection is near the second side 711B of the first lateral surface 711.

In one embodiment, the shape of the first electrode 707 is substantially zigzag-shaped. The shape of the first electrode 707 can have any suitable shape which can be well-designed by a designer. By using the stacking structure (e.g., an electrode) in FIG. 8A to FIG. 8F for aligning the conductive element 703, it doesn't need a more complex process. The larger the number of the conductive layers to be used is, the more the number of the additional processes to be saved is. It can not only greatly save the cost but also improve the performance of electrical connection between the first electrode 707 and first terminal 703A of the conductive element 703. Moreover, the zigzag-shaped first electrode 707 can improve the yield of soldering of the first electrode 707 in SMT process.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electronic component, comprising:
a conductive element; and
a plurality of insulating layers, wherein the conductive element is disposed in the plurality of insulating layers, wherein the plurality of insulating layers are not supported by a substrate.

2. The electronic component according to claim 1, wherein the plurality of insulating layers comprise at least one of epoxy, oxide, a polymer-base material or a magnetic material.

3. The electronic component according to claim 1, wherein the conductive element is a coil or an inductor.

4. The electronic component according to claim 1, wherein the plurality of insulating layers comprise a top insulating layer, a plurality of median insulating layers and a bottom insulation layer, wherein the conductive element is substantially disposed in the plurality of the median insulating layers.

5. The electronic component according to claim 4, wherein the thickness of the top insulating layer is greater than that of each of the plurality of median insulating layers.

6. A method for manufacturing an electronic component, the method comprising the steps of:
a. providing a substrate;
b. forming a conductive element and a plurality of insulating layers on the substrate, wherein the conductive element is disposed in the plurality of insulating layers; and
c. decoupling the substrate from the plurality of insulating layers.

7. The method according to claim 6, wherein the substrate is a glass substrate.

8. The method according to claim 6, wherein step a further comprises forming a buffer layer on the substrate.

9. The method according to claim 8, wherein step c further comprises decoupling the buffer layer from the plurality of insulating layers before decoupling the substrate.

10. A package structure, comprising:
a conductive element, comprising a first terminal;
a body, comprising a first lateral surface with at least one first opening thereon; and
a first electrode electrically connected to the first terminal, wherein the first electrode comprises a first segment substantially disposed in the body, wherein at least one portion of the first segment is exposed to the first lateral surface via the first opening.

11. The package structure according to claim 10, wherein the area of the first opening is substantially at least one-third the projection area of the first segment on the first lateral surface.

12. The package structure according to claim 10, wherein the area of the first opening is substantially at least one-third that of the first lateral surface.

13. The package structure according to claim 10, wherein the height of the first segment has is substantially at least one-third that of the first lateral surface.

14. The package structure according to claim 10, wherein the first segment and the first lateral surface are separated by a first distance.

15. A stacking structure, comprising:
a substrate having a first lateral surface and a second lateral surface opposite to the first lateral surface; and
a plurality of conductive layers disposed in the substrate, wherein each two adjacent layers of the plurality of conductive layers are contacted each other in a contact region, wherein the contact regions of the plurality of conductive layers are interleaved along the first lateral surface and the second lateral surface.

16. The stacking structure according to claim 15, wherein each of the plurality of conductive layers is a strip-like pattern.

17. The stacking structure according to claim 15, wherein the contact regions are disposed in a first plane perpendicular to the bottom surface of the substrate.

18. The stacking structure according to claim 15, wherein the contact regions comprises:
at least one first contact region disposed along the first lateral surface and substantially disposed in a first line; and
at least one second contact regions disposed along the second lateral surface and substantially disposed in a second line, wherein the first line and the second line are substantially perpendicular to the bottom surface of the substrate.

19. The stacking structure according to claim 15, wherein the plurality of conductive layers comprising:
at least one first conductive layer substantially extending in a first non-horizontal direction; and
at least one second conductive layer substantially extending in a second non-horizontal direction.

20. The stacking structure according to claim 15, wherein the substrate is a PCB.
